(19) United States
(12) Patent Application Publication
(10) Pub. No.: US 2009/0253476 A1
(43) Pub. Date: Oct. 8, 2009

(54) Trivia game and system

(76) Inventor: John A. Pestotnik, West Des Moines, IA (US)

Correspondence Address: DARDI & ASSOCIATES, PLLC, 220 S. 6TH ST., SUITE 2000, U.S. BANK PLAZA, MINNEAPOLIS, MN, 55402, US

(21) Appl. No.: 12/080,954

(22) Filed: Apr. 8, 2008

(51) Int. Cl. A63F 9/24; A63F 13/08

(52) U.S. Cl. 463/9; 463/46; 463/43; 463/34

(57) ABSTRACT

An embodiment of the invention is a trivia entertainment system providing for free association of recordings and trivia through a free form hosted selection process.

### TECHNICAL FIELD

The field of the invention relates to a trivia game or entertainment system.

### BACKGROUND

Trivia games are a popular form of entertainment. Some games are pen-and-paper or board games, while others incorporate a video screen for displaying questions.

### SUMMARY OF THE INVENTION

The invention, in some aspects, relates to a hosted music or other-media trivia game. As explained below, computing devices can be used to create a sophisticated play environment via a free-association interface and engine in a free-form format. The host, in a preferred embodiment, plays a song or other media from his/her own media library using a media player and then uses a graphical user interface to pull-up catalogs (e.g., a scroll-bar) of trivia items related to the song. Hints may further be associated in a user interface with the media and the trivia items. Disclosed herein are techniques and systems that allow rapid and detailed control of trivia and/or hints in the game by a host and presentation of the trivia and/or hints to game players in conjunction with coordinated control to play music or other recordings.

For instance, players attempt to identify attributes related to the currently playing media item, attempt to identity elements of associated information lists and attempt to answer quiz questions. Hints may be provided to assist players in answering questions and to add entertainment value through the use of word play techniques such as pun, homophone, double entendre, and so forth, and through the interjection of additional facts. A free-association aspect of the game expands content well beyond media trivia, making the game interesting to all audience members regardless of their areas of knowledge. The free-association may be hierarchical to ensure trivia content is available irrespective of the media library content. Free-form host control enables the host to dynamically tailor the flow of the game, the pace of the game and the content selection to the audience.

An embodiment of the invention is a trivia entertainment system comprising a computing device, a host display, a viewer display, a computer-readable medium, a library of media elements comprising musical and/or video recordings that are each associated with a plurality of attributes, said library being stored on the computer-readable medium, a media player for playing the recording according to selection by a host or a predetermined playlist, a database comprising trivia records each associated with one or more attributes, said database being stored on the computer-readable medium. The computing device can be used for providing a graphical user interface controllable by a host on the host display, having access to the library and the database, being programmed to match attributes of the recordings with attributes of the trivia records to provide a plurality of trivia catalogs to the graphical user interface, and being programmed to respond to the graphical user interface to display a portion of the trivia on the viewer display. The graphical user interface can be used that provides integration with the media player to retrieve and display the attributes of the recording on the host display, exhibits the plurality of trivia catalogs, and provides for host-selection of a trivia item from the plurality of trivia catalogs to display on the viewer display. The recording attributes may comprise a member of the group consisting of a year associated with the recording, a name of a performer on the recording, a record label that released the recording, a title of the recording, an author of the recording, a composer of the recording, and combinations thereof. The system may use a plurality of the viewer displays. The computing device may be, for example, a computer that comprises the computer-readable medium for the library, or the database, or both the library and the database. The system may have an audio or video media player controllable through the graphical user interface to play the recording, with the recording being a musical or videographical recording. The recording may be taken from the predetermined play list and automatically played. The system may further provide for host control of the media player through the graphical user interface. Another embodiment is a method of playing a hosted game with viewers that interact with a viewer display comprising: providing an entertainment system that comprises a computing device, a host display, a viewer display, a computer-readable medium, a library of media elements comprising musical and/or video recordings that are each associated with attributes, said library being stored on the computer-readable medium, a media player, a database comprising trivia records each associated with one or more attributes, said database being stored on the computer-readable medium, and a host graphical user interface controllable on the host display; selecting the recording for playing by a host or a predetermined playlist, with the system retrieving and displaying a plurality of attributes of the host-selected recording in the graphical user interface; matching, with the computing device, attributes of the recording with attributes of the trivia records to provide a plurality of trivia catalogs to display in the graphical user interface; and selecting at least one of the trivia items from at least one of the trivia catalogs via the graphical user interface to direct the controller to display the at least one selected trivia item on the viewer display. The method may be used further comprising a plurality of viewer displays that display the selected questions and/or facts. Exemplary recording attributes may be a member of the group consisting of a year associated with the recording, a name of a performer on the recording, a record label that released the recording, a title of the recording, an author of the recording, a composer of the recording, and combinations thereof. Further, the trivia attributes may include a year, and the computing device matches the year of the recording with the year of one of the trivia records, and the GUI provides the catalogs in separate classes.

### BRIEF SUMMARY OF THE FIGURES

FIG. 1 is a pictorial diagram illustrative of exemplary trivia game system;

FIG. 2 is a pictorial diagram of an embodiment that has a trivia database;

FIG. 3 is a pictorial diagram illustrating an embodiment of the trivia database of FIG. 2 that has various tables and table relationships;

FIG. 4 is a pictorial diagram exemplifying a system with an administrative module and a host module;

FIG. 5 is a pictorial diagram illustrating an embodiment of a trivia game system;

FIG. 6 is a flow diagram of one of the embodiments that illustrates a host interaction with host module within a trivia game system;

FIG. 7 depicts a graphical user interface (GUI) for a trivia entertainment system;

FIG. 8 depicts a host control option for the GUI of FIG. 7;

FIG. 9 depicts a host control option for the GUI of FIG. 7;

FIG. 10 depicts a host control option for the GUI of FIG. 7;

FIG. 11 depicts a host control option for the GUI of FIG. 7;

FIG. 12 depicts a host control option for the GUI of FIG. 7;

FIG. 13 depicts a host control option for the GUI of FIG. 7;

FIG. 14 depicts a host control option for the GUI of FIG. 7;

FIG. 15 depicts a host control option for the GUI of FIG. 7;

FIG. 16 depicts a host control option for the GUI of FIG. 7;

FIG. 17 is a table diagram depicting events in an exemplary control program;

FIG. 18 depicts a host control option for the GUI of FIG. 7;

FIG. 19 is a flow diagram illustrating a flow process for a hosted process;

FIG. 20 is a flow diagram illustrating a flow for a hosted process for guessing the year of a song playing in real time;

FIG. 21 is a flow diagram illustrating the flow for a hosted process for editing and displaying song lyrics;

FIG. 22 is a flow diagram illustrating a flow for process called when a sing button is clicked;

FIG. 23 is a flow diagram illustrating a flow for a process called when a TV ratings button is clicked;

FIG. 24 is a flow diagram illustrating a flow for a process called when a movie guess button is clicked;

FIG. 25 is a flow diagram illustrating a flow for a process called when a list guess button is clicked;

FIG. 26 is a pictorial diagram illustrating an optional set of game components that can be used to provide audience members with a sophisticated way to indicate when they want to respond to a question.

### DETAILED DESCRIPTION OF PREFERRED EMBODIMENTS

The invention, in some embodiments, is a music trivia game implemented by software that plays music and associates the music with trivia. Advantages of the system include the way that the association is performed, certain trivia content, how and what trivia is displayed, and the hosted interface for the game that allows control of the association process and display of the trivia. Other embodiments include video or other media as an alternative to, or in addition to, music.

Free-association processing that provides trivia and/or facts for a host to use and display using the system is described in detail below. In some aspects, the processing can use media attributes, e.g., song title and artist name to locate and select corresponding records within the database exposing additional attributes not available within the media library. Attributes from both the media library and database then serve as the basis for trivia and fact selection through data filtering techniques. Hierarchical data selection may be used to expose facts and trivia that may directly relate to the media item being played, those that may be indirectly related through a common attribute, and those that are universally available regardless of the current media item. Such a hierarchical approach ensures availability of trivia content regardless of the host's media library content. The host then controls the selection of specific player-displayed facts and trivia through a graphical user interface (GUI). A GUI may be used by the host in a free-form mode to select among the trivia and/or facts suggested by the free association processing. The free-form mode does not bind the host to use of particular questions or merely filtering questions; instead, the host can freely and independently choose the information for display to users. The host may use the GUI on a host display and provide the trivia and/or facts to viewer displays for viewing by an audience. These features contrast with an approach that might involve retrieving media that is specifically indexed to a predetermined list of questions, or displaying questions without meaningful control by a host.

By way of example, in an embodiment of the invention, a library of music recordings may be associated in a computer with attributes related to the music, such as a title of the musical piece, a performer, a composer, or a date. For instance, an attribute may be a date that is the date of release. A database provides trivia. An application matches attributes of the recordings to attributes within the database of the trivia. A host selects songs in real time, or uses a media player to automatically select songs from a play list. An application recognizes a currently playing recording by matching attributes of the recording to attributes within the database of trivia. A GUI provides the trivia to the host; a host uses the GUI on a host display to select trivia to present to viewers via a viewer display. For instance, a host might select the Beatles' Love Me Do song having these attributes: composed by Lennon/McCartney, performed by the Beatles, first recorded at Abbey Road Studios in 1962, released in 1962 as a single with B-side “P.S. I Love You” on the Parlophone or Tollie label, produced by George Martin, placed on the Please Please Me album”. The software application's association engine would then review its database of content to retrieve trivia and/or facts based on associations with music attributes. Possibilities might include, either as a declarative fact or posed as a in a question-and-answer format: “Twist and Shout” was on the Please Please Me album; Lennon/McCartney also coauthored “I Wanna Be Your Man” released by the Rolling Stones and “A Day in the Life” released by the Beatles; the population of the U.S. was about 186 million in 1962; Brazil won the World Cup in 1962; The New York Yankees won the baseball World Series in 1962; Johnny Carson started hosting the Tonight Show in 1962; a video clip of Johnny Carson on the Tonight Show; a video clip of Brazilian soccer players; the Yankees playing the San Francisco Giants; a video clip from a 1962 television commercial or movie. The host then may review the trivia items and select one or more of them for display to the viewers. The host uses the GUI to play the music and/or displays one or more trivia items as desired. The free association engine is thus advantageously more powerful than a program that merely provides prechosen information such as question-and-answer sets matched to a particular recording. An alternative embodiment of the invention is media-driven, whereby the application provides for a host to create a predetermined list, with the application automatically retrieving a recording as determined by the predetermined list and retrieving musical or other attributes to generate catalogs of trivia for selection by the host to display to a viewer. The term catalog refers to a plurality of items available for choosing for further processing; for instance, a scroll bar, pop-up window, or items displayed by mouse-over.

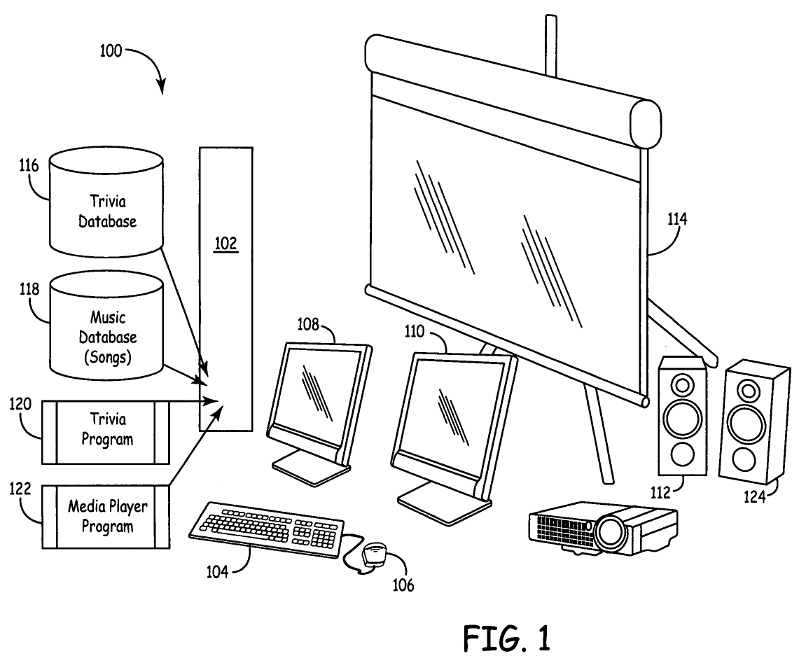

FIG. 1 is a pictorial diagram illustrative of exemplary trivia game system. While the illustrated exemplary trivia game system 100 is a hosted game, it is to be understood that the game could also take the form of a non-hosted game in which a person interacts with the system alone. A hosted trivia game is one in which a host (a person, e.g., a disc jockey (DJ)) facilitates the game to an audience (people), also referred to as viewers in the context of viewing displays intended for the audience.

The illustrated trivia game system 100 includes a computing device 102 connected to a plurality of display devices 108, 110 and 112 that generate a display. The term computing devices refers to a computer, personal digital assistant, a notebook computer, or other suitable devices, for instance a device with digital storage media and a microprocessor for executing instructions stored in a computer readable medium. One display device 108 serves as the host display and is used in combination with keyboard 104 and mouse 106 or other similar computer cursor control device such as touch pad or stick pointer, for instance by interaction with a graphical user interface (GUI) that a host may use to direct the displays and direct the system. One or more additional display devices 110 and 112 provide the viewer displays. A large screen 114, wall or other large viewable medium may be used when the audience consists of a sufficiently large number to require it. The illustrated trivia game system 100 also may include speakers 124 or other audio devices necessary to project sound to the audience, which may or may not be viewing the viewer displays. The illustrated hosted trivia game system 100 includes, or accesses, a trivia database 116 that contains trivia content such as facts and/or questions and may reside on the computing device 102 or at a remote site, e.g., as through an internet interface. Information contained within the trivia database 116 may be accessed by a trivia program 120 that also resides on the computer system 102 or other computer readable media, e.g., a flash drive, personal digital assistant, or a remote server. The term information refers to information intended for reading or direct viewing by a human user, and is in contrast to data used or stored for machines to communicate with each other. The trivia program 120 supports host interaction through the keyboard 104 and the mouse 106, similar cursor control devices, or as otherwise suited to the application, e.g., via a Wii®®console. The trivia program 120 also may support host interaction through the use of one or a plurality of display devices 108 and 110 and audience interaction through the use of one or a plurality of display devices 112. The illustrated trivia game system 100 may include a music database 118 that contains a plurality of songs, song metadata, play lists, video recordings, also referred to as the library or media elements. The term recording broadly refers to music or visual information that is stored and played via a computing device. Information contained within the library may be accessed through a media player program 122 that resides on computing device 102 or other devices accessible through control of the system, e.g., a remote server or local computer readable media. The media player program 122 may be used to control the playback of songs in an audio format over speakers 124 or the audio portion of a video recording.

An exemplary trivia game system includes a video database (also referred to as a library) in place of or in addition to music database 118 or other library of audio and/or video recordings. By way of example, trivia game system video clips may be presented by the media player program 122.

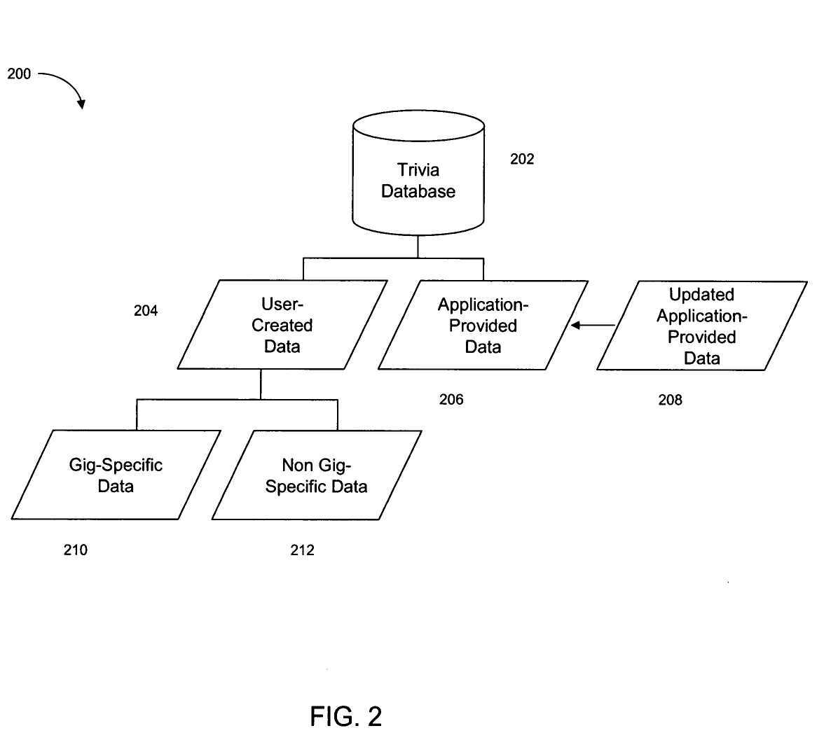

FIG. 2 is a pictorial diagram of an embodiment that has trivia database 202. The trivia database 202 includes a set of data 206. Data 206 may include attributes relating to a plurality of artists, songs, albums, television (TV) shows, movies, historical events, miscellaneous categorizations, lists and/or associated list items. Data 206 may include facts that are employed by the trivia game system 100 as audience hints when so directed by a host or the trivia program 120. Data 206 may include trivia information that relates to various categories including artists, songs, albums, TV shows, movies, historical events, miscellaneous categories and elements of lists.

The software application, e.g., trivia program 120, may provide users (such as the host) with data 206, referred to as application-provided data; in one embodiment, the application does not include a media library and, instead, only accesses such a library, which is located either locally or remotely, for instance on a computer-readable media. In such an embodiment, the program includes facts and/or trivia, as in data 206, but relies on access to a media library that has attributes associated with the media content, with those attributes being retrievable by the program. Thus the application may exclude library content, i.e., exclude audio and/or vide recordings. This feature advantageously provides for applications that can use the media libraries provided by other sources, e.g., ITUNES. Accordingly, a user with authorized access to such sources may pick and choose content to purchase from such a source and use such content in the trivia system described herein. Such application may further include instructions for interfacing with, or providing a GUI operable by the host as described herein.

Those skilled in the art will appreciate that data 206 can be regularly replaced with updated data 208. Providing updated application-provided data is a service that adds continuous value to end users of the trivia game system 100. In some embodiments, users subscribe to an updating service, or choose updates, through internet-based communications or by mailing of data, e.g., as a compact disc or DVD.

Trivia database 202, in some embodiments, accommodates user-created data. This allows hosts/DJs to customize a trivia game system to their own interest and to their own music database. By adding their own content, hosts are able to differentiate themselves from competitor hosts, even those utilizing this same trivia game system. This feature adds significant value to hosts. The trivia database 202 also accommodates both gig-specific and non gig-specific user-created data 204. Gig-specific data 210 is specific to a unique hosted event, e.g., a specific class reunion. Gig-specific data 210 may be presented only during the trivia session for that specific gig. The inclusion of gig-specific data 210 allows hosts/DJs to customize content for a specific gig, adding value to their clients and further differentiating themselves from their competitors.

Those skilled in the art will appreciate that the trivia database 202 may be configured to preserve some or all of user-created data 204 when updating data 206.

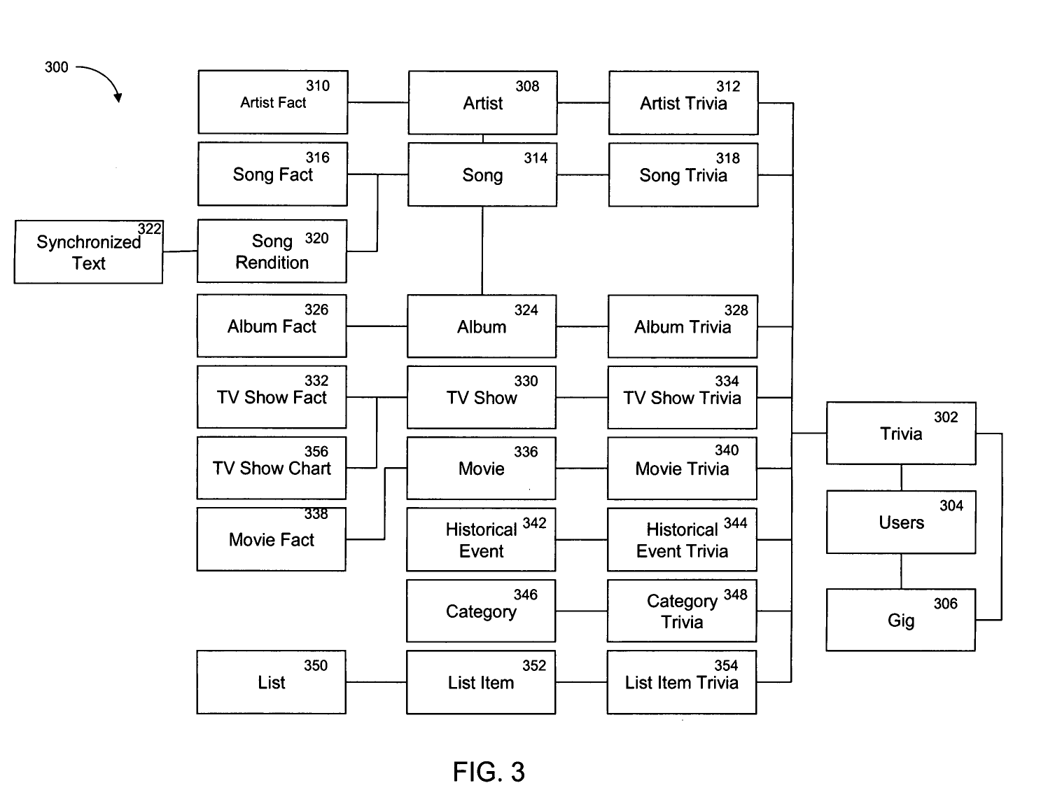

FIG. 3 is a pictorial diagram illustrating an embodiment of trivia database 202 that has various tables and table relationships. Such a table structure and the attributes of the various tables can be used to provide the foundation for free-association trivia, which provides many advantages, e.g., providing many options for a host to generate or choose facts and/or trivia for display.

In this embodiment, trivia table 302 may include, for example, a plurality of records each containing attributes that are a specific trivia item. The term attribute refers to searchable data strings or data elements. Trivia is a set of related attributes or information, e.g., text, a graphical image, a fact, a question, an answer, a list of answer choices. Each trivia record may be related to one of the categories for trivia including artist, song, album, television (TV) show, movie, historical event, category, and list item. An item within any given category embodies a set of attributes that are specific to that category. For this reason, category items are stored within separate tables on the database. A record is a datum in a dataset. A list item is a specific element within a list of related elements. A popular automobile model, for example, is a list item within a list of popular automobile models for a specific year. Lists are interesting and provide entertainment value when incorporated into a trivia game.

A set of intermediate tables may be used to connect trivia items to category items in order to greatly simplify application logic involving trivia items and to accommodate expansion of trivia classes without necessitating logic changes to trivia-related aspects of the application. The use of these intermediate tables prevents each trivia item from having to store an identifier relating to each of the category tables and prevents the application from having to conditionally determine which identifier is actualized for any given trivia item instance. The approach employed is superior to the alternative approaches that involve establishment of individual trivia tables for each class or the inclusion of a plurality of class identifier within each trivia record, only one of which contains a valid reference. The selected approach allows for one common set of logic to be used within the system for all functions involving trivia items. The alternative would require extensive conditional and redundant logic throughout the application wherever trivia items are utilized. Those skilled in theses arts, after reading this specification, will appreciate how this simplifies the trivia program 120 and makes the application more flexible to accommodate additional categories of trivia without requiring changes to the program components dealing with trivia.

Referring to the embodiment of FIG. 3, a user may, for example, select a song from a recording database and use a GUI that recognizes attributes of the song. The underlying software application uses the artist name attribute of the song to search artist table 208 for records that match the artist. The artist may have a numerical identifier. The software will review artist fact table 310 for items that match the numerical identifier; as explained below, the fact items may be processed into the GUI as a catalog of hints in the artist class of the GUI. The software will further review artist trivia table 312 to find records that match the unique identifier for the artist; these records may have another identifier, which is then used to match unique identifiers for trivia in trivia table 302. Such trivia will then be made available as a catalog in the GUI in the artist class. An example of a catalog is a scroll bar. Tables 208, 314, 324, 330, 336, 342, 346, and 352 each are analogous to table 308, and may be used as a class in the GUI. Class is a term referring to a group of items with common features. Similarly, tables 318, 328, 224, 240, 344, 348, and 354 are analogous to table 312. Similarly, tables 316, 320, 326, 332, 356, 338, and 350 are analogous to table 310. These features are explained in more detail below.

In some embodiments, table 310 and its analogous tables contain facts that may be used as hints, which are declarative statements or phrases (facts) or interrogatives (questions). The separation of hints and trivia is significant since the hints must point to the trivia without stating it. In the embodiment of FIG. 3, the hints are not available on a 1:1 match with trivia because there may be many, or a plurality, of hints that are available in a class and a plurality of trivia items that belong to the same class. In use, a GUI may display a catalog of the hints (facts and/or questions) and a catalog of trivia; the GUI may be programmed to place these items in the same class. Thus FIG. 3 illustrates how to solve a difficult problem of providing many, or a plurality of, trivia items and many hints that are applicable to the trivia items, and solves the problem in a way that is advantageous for programming and for data entry.

A class, in general, may also be used as a grouping or categorization mechanism for trivia not falling into one of the other classes. This category does not include category-specific attributes. Its attributes include a category description and category identifier. It supports expansion of trivia categories without limitation for categories of trivia where additional class attributes are not required. These expanded categories of trivia can be added dynamically by users without programming modification. Examples of such categories may include: drummer jokes, city trivia, book trivia and virtually any other category that a user can come up with.

A class, in general, may also be used as an item within a list of items. List items may have related trivia. List items are unique, however, in the fact that they relate to a list within the list 350 table. Lists provide a powerful and entertaining aspect to the game whereby game players may try to identify items within a specific list. A list item may be year specific or may not. Lists can be expanded without limitation. Lists and list items can be added dynamically by users without programming modification.

The trivia 302 table may include, for example, the following attributes: unique identifier, a public/private indicator, a trivia question, the correct answer, a plurality of incorrect answers, trivia item in the form of a statement, date last used, sequence value, gig identifier, difficulty level, image file name, user ID, date added, and/or a plurality of hints. The pubic/private indicator differentiates user-created data 204 from application provided data 206. The correct answer and plurality of incorrect answers are used to present the trivia in the form of a multiple choice question to the audience. Presenting multiple choice answers may be at the discretion of the host and is may be used as a hint to help viewers guess the correct answer. The date last used is a mechanism by which trivia questions are removed from the pool of available trivia within a specific trivia session or gig. The sequence value provides a mechanism by which trivia can be prioritized or randomized. Gig identifier provides the mechanism for inclusion/exclusion of gig-specific trivia. Difficulty level enables trivia to be filtered based on a perceived level of difficulty. Image file name serves as a reference to a graphical image to be displayed (e.g., automatically or optionally under control of a host) in concert with the trivia. User id and date added support tracking and reporting trivia back to the original contributor. A plurality of hints is one of the advantageous features of this embodiment of trivia game system 100. The host controls the display of hints that can be other interesting facts and trivia. The use of trivia hints keeps the game at a fast pace and continues to engage the audience even if they do not immediately know the correct answer to the trivia question.

The user 304 table may include, for example, the following attributes: user ID, password, email address, name, address, telephone number, and/or security classification. The user information is used to control access to the trivia game system 100 and is used to determine whether users can update application-provided (public) data 206 or can only update user-created (private) data 204.

The gig 306 table may include, for example, the following attributes: user ID, unique gig ID, gig date and/or gig description. A gig represents a specific engagement to be hosted by a host. It provides a mechanism by which the trivia game system 100 can be licensed on a per gig basis.

The artist 308 table includes, for example, the following attributes: unique identifier, a public/private indicator, and/or the artist name, optionally stored in a special compressed format. A compressed format for artist name is used to prevent inadvertent duplication of artists on the database in the event there slight deviations in the way the artist name is entered in terms of special characters, spaces, capitalization and parenthetical terms. The compressed format for artist name enhances the way artist name matching is performed and by providing a match criteria more forgiving than an exact character-by-character matching algorithm. Those skilled in the art will appreciate the ramifications of such a flexible matching algorithm after reading this specification.

The artist 308 table is related to the artist fact 310 table. The artist fact table includes, for example, the following attributes: unique identifier, a public/private indicator, the unique identifier for the related record on the artist 308 table, and/or the fact and the date the fact was last used. Facts may be used as hints when the audience is trying to guess the name of the artist for the currently playing song or other media. The hints provide an interesting and interactive source of additional information that keeps the game fast paced and keeps the audience engaged even if they do not immediately recognize the artist. The use of artist facts/hints is an advantageous feature of an embodiment of the trivia game system 100. Hints may include entertaining items such as “sounds like”, “puns, “fill in the blank”, “name in common with ______” and other creative and entertaining ways to help the audience guess the artist. The optional use of such hinting techniques is another advantage of the trivia game system.

The artist 308 table is related to the trivia 302 table by way of the artist trivia 312 table. The artist trivia 312 table may include, for example, the following attributes: a public/private indicator, the unique identifier for the trivia record, and/or the unique identifier for the artist record. The use of this intermediate record enables functionality related to the trivia 302 table to be common for all types of trivia. Those skilled in the art will appreciate how flexibility and maintainability of the system is improved through this approach. The song trivia 318 table, album trivia 328 table, TV show trivia 334 table, movie trivia 340 table, historical event trivia 344 table, category trivia 348 table and list item trivia 354 table, each serve the same purpose as the artist trivia 312 table for their respective related entities. Each may be set up with essentially identical attributes with the exception that each may contain a unique identifier for their appropriate entity instance in place of the artist unique identifier.

The song 314 table, album 324 table, TV show 330 table, movie 336 table, historical event 342 table, category 346 table and list item 352 table serve an identical purpose as the artist 308 table described above. The only notable difference is that each contains attribute relevant to its character.

The song fact 316 table, album fact 326 table, TV show fact 332 table, and movie fact 338 table serve an identical purpose as the artist fact 310 table. The attributes for each are identical with the exception that each contains the unique identifier for its related entity instance in place of artist unique identifier.

The song rendition 320 table may include, for example, the following attributes: a unique identifier, a public/private indicator, the unique identifier for its related song 314 record and/or a rendition description. The rendition serves to disambiguate the relationship between a song and synchronized text 322. This disambiguation is helpful because there can be multiple recordings of the same song present. Each may have different timings and each may even have slightly different lyrics. Likewise, there may be multiple sets of text to be synchronized with playback timing for a specific recording of a song. One, for example, may include song lyrics. One may include trivia questions and answers to be synchronized with the playback timing of the song lyrics.

The synchronized text 322 table may include, for example, the following attributes: a unique identifier, a public/private indicator, the unique identifier for the related song 314, the unique identifier for the related rendition 320, the timing for display of specified text in milliseconds relative to the beginning of the audio playback of the song and the text to be displayed in synchronization of the playback of the song. Synchronized text can be used in a variety of unique ways within the trivia game system 100. Synchronized text can be used to display song lyrics in synchronization with the song audio playback. This feature can support audience sing-a-long, for example. It can be used to associate lyric-related facts to the audio playback of a song. It can be used to associate lyric related trivia questions and answers automatically in synchronization with audio playback of the song. It can be used to associate satirical lyrics to the song. Through the use of qualifying renditions, all of the aforementioned can be associated with the same recording of a specific song. Those skilled in the art will appreciate entertainment value to be derived through the various uses of synchronized text. They will also appreciate the recognition that the same song may have many adaptations and that the synchronized text is rendition-specific.

Another advantageous feature that may be included is an administrative tool enabling the end user (host) to easily establish his/her own text synchronizations. This feature can be accomplished by, for example, a one or two-pass approach. Synchronization of song lyrics, for example, can be easily accomplished in a one-pass approach as follows. Obtain song lyrics. Paste song lyrics onto screen. Begin playing the song on the media player program 122. Press the button to start synchronization. The program displays the lyrics one stanza at time. As soon as the first stanza is, press the “next” button. Continue pressing the “next” button each time the next stanza is heard. Press “done” when complete. The system automatically adjusts the timing slightly to account for reaction time and to give the audience a slight head start when reading synchronized text. In about the length of time it takes to play the song, the end user has established synchronized lyrics. The simple elegance of this approach is an advantage for this trivia game system 100. A two-pass approach is nearly identical with the exception that the end user plays the song back twice. Once to clean up any lyric discrepancies, and once to establish synchronization timings.

The TV show chart 356 table may include, for example, the following attributes: unique identifier, TV season (year), chart position, unique identifier for related TV Show 330 and/or the network airing the TV show that season. The TV show chart 356 table supports two aspects of the trivia game system 100. It supports a guessing game where the audience tries to guess top ranking TV shows for a specified year. It also can serve as a hint mechanism whereby top ranking TV shows are revealed without revelation of the year to be used to help the audience guess the year in question, the year related to the release date of the currently playing song. Essentially identical functionality exists for top ranking movies to be used in a guessing game and in a hint capacity when trying to guess the year in question.

TV shows require a TV show chart 356 entity because one TV show may appear for many years and occupy different ratings positions each year. Movies, however, do not require a chart entity since their ranking is based on their release year exclusively.

The list 350 table may include, for example, the following attributes: unique identifier, a public/private indicator, and a list name. Each list has associated list items 352. Lists support both list item-related trivia and a list item guessing game similar to the guessing game for top rated TV shows and top rated movies. Lists can include any types of interesting sets of information and may or may not be year specific, i.e. include a separate set of list items by year.

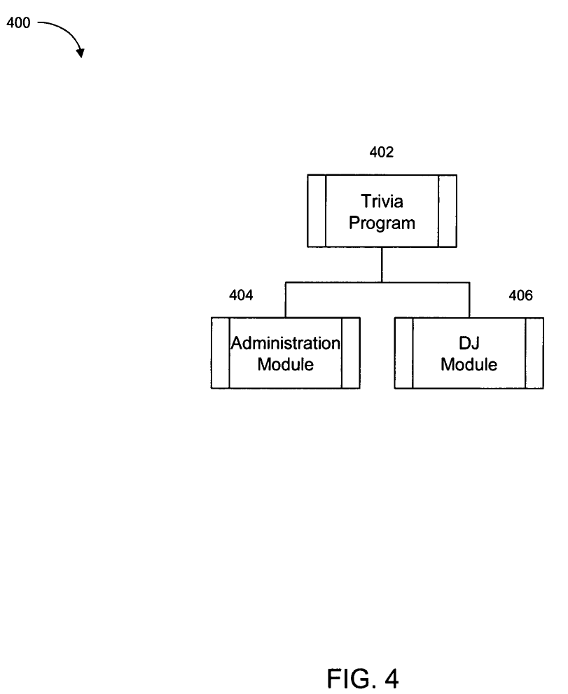

FIG. 4 is a pictorial diagram illustrating how the trivia program 402 may have two modules—the administrative module 404 and the host module 406. The administrative module is used by both staff supporting the trivia game system 100 in terms of maintenance of application-provided data 206 and by hosts maintaining their own unique user-created data 204. The administrative module is used to maintain trivia content. The host module 406, on the other hand, is used during gigs to entertain an audience.

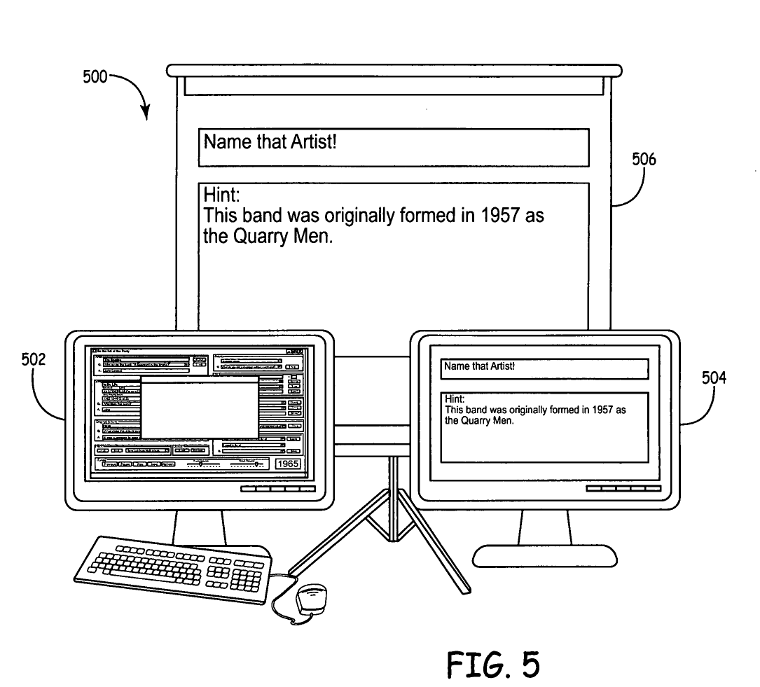

FIG. 5 is a pictorial diagram illustrating an embodiment of trivia game system 100. It illustrates how the host console 502 (viewable by host but optionally not by a viewer or audience member) displays different information from the audience display 504 and 506 (viewable by audience and host). In this embodiment, all system control may be achieved through interaction with a host console via a keyboard and mouse or similar device. The separation between host-viewable data and audience and host-viewable data is significant. It enables the host to preview questions, answers, hints, and so forth, and tailor each execution of the game to the audience. The same identical song list can generate almost an infinite number of unique trivia sessions based on host selections. The use of dual display content projected onto two or more display devices is a significant advantage for hosted trivia. The visual component advantageously entertains the audience visually, overcomes noise problems in loud public venues such as bars, and opens up the trivia experience to hearing impaired individuals.

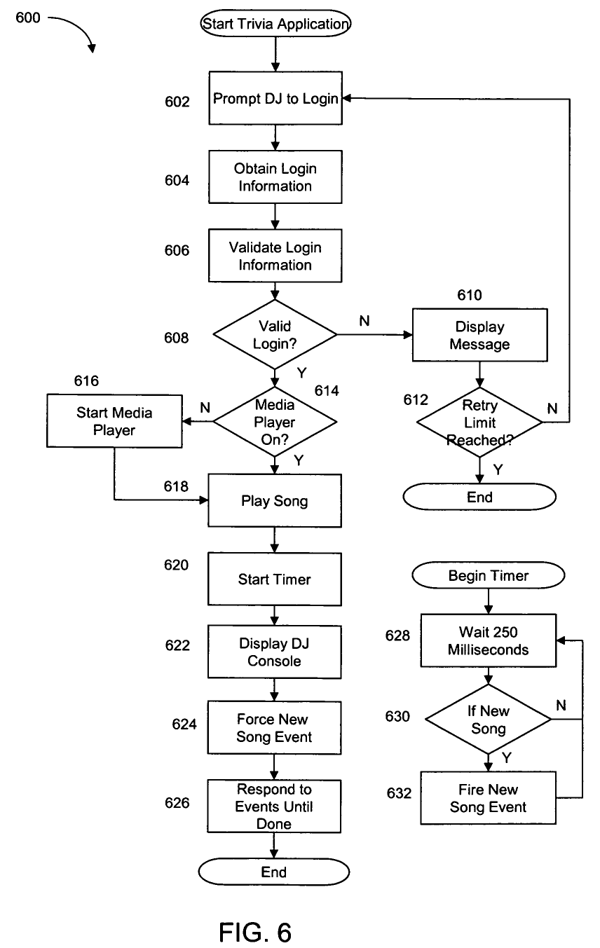

FIG. 6 is a flow diagram of one of the embodiments that illustrates a high level flow 600 for host interaction with host module 406 within trivia game system 100. As the trivia application is initiated, the host (e.g., DJ) is prompted as at logic at block 602. The DJ will login by entering a user ID, password, gig identifier and system-assigned gig key at block 604. The gig key is obtained by the DJ when registering the gig via a web site or telephone call. It is a security device to ensure that DJ's may only use the trivia game system 100 if they have registered and paid for the use. The assignment of a gig key that will only work for the specified DJ user ID, on the specified gig date, on the pre-registered computer helps to ensure that all system usages are legitimate. Additionally, application access is enabled by the use of a dongle containing DJ specific information. A counter on the dongle is established when the dongle is mailed. The counter is decremented with each gig login. The dongle is used as a reconciliation device to ensure that DJs to not try to manipulate the system to obtain free access by reverting to backup files, changing the system date or by other similar means. At block 606 the DJ-entered information is validated using three techniques—database validation of user id information, validation of the gig key by use a hashing algorithm and detection of an appropriate, validated dongle with remaining uses on its usage counter.

At decision block 608 a decision is made whether to proceed into operation of the DJ module or to display an appropriate login error message. At block 610 an appropriate error message is displayed and the retry count is incremented. At decision block 612 a decision is made whether or not the maximum number or login retries has been reached. If so, the program is terminated. If not, control passes back to block 602 to prompt the DJ to login again.

At decision block 614, the system determines whether or not the media player is operating. If not, the media player is started in block 616. If so, the song is played through communication with the play button on the media player. Once the song is started, a timer is started. Block 628 shows that the timer fires every 250 milliseconds. Each time the timer fires, the system tests to see if a new song is playing as shown in decision block 630. If so, the new song 1702 event is fired.

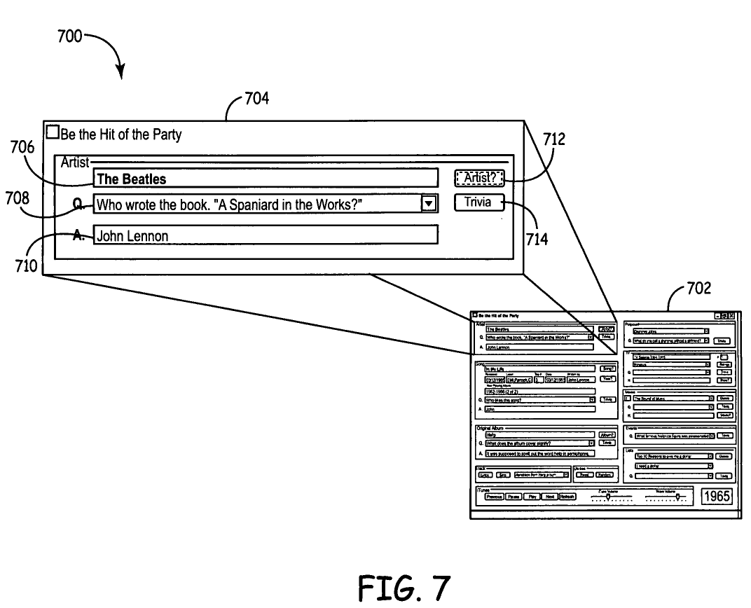

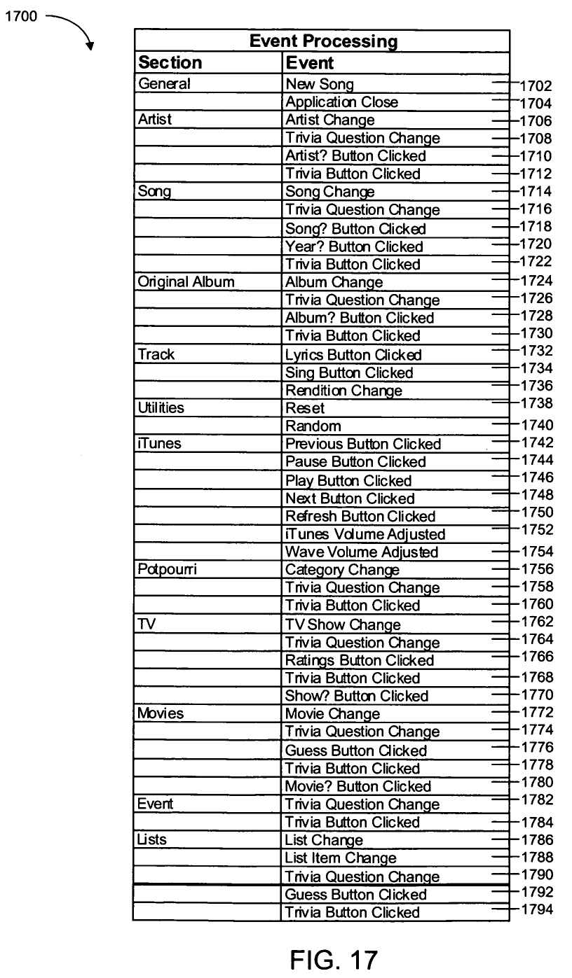

After initiating the timer, block 622 displays the DJ console form and block 624 forces the new song 1702 event. At this point there is no pre-determined flow for the program. It is an event driven system where events initiated through DJ interaction with form controls and new song events dictate the course of events. It is this free-form flow that gives the DJ so much latitude in controlling the game and creates a free-association experience for the audience. It is also this free-form flow that makes each gig completely unique even when the same song play list is used. FIGS. 7-16 describe each of the control components optionally within the DJ's control. FIG. 17 describes each of the plurality of events that occur and the logic each imparts. A plurality of data filters within the DJ console form interact to change the available trivia based on both the new song event and choices made within the context of drop down lists.

FIG. 7 is a pictorial diagram exemplifying a GUI having controls within the artist section 704 of the DJ console form 702. The artist name text box 706 derives the value of its contents from artist information exposed through communication with the media player program 122. The artist trivia drop down combo box 708 contains some or all currently available trivia questions directly related to the artist shown in the artist name text box 706 as determined by the currently playing song. The background artist trivia data source is filtered based on a matching unique artist ID and last used date/time more than 24 hours old. The answer reflected in the artist trivia answer text box 710 is derived from the current selection in the artist trivia drop down combo box 708. The DJ may change the selection with the artist trivia drop down combo box 708 at any time assuming more than one selection is available based on the filtered data. Changes to the artist trivia drop down combo box 708 cause an immediate change to the contents of the artist trivia answer text box 710.

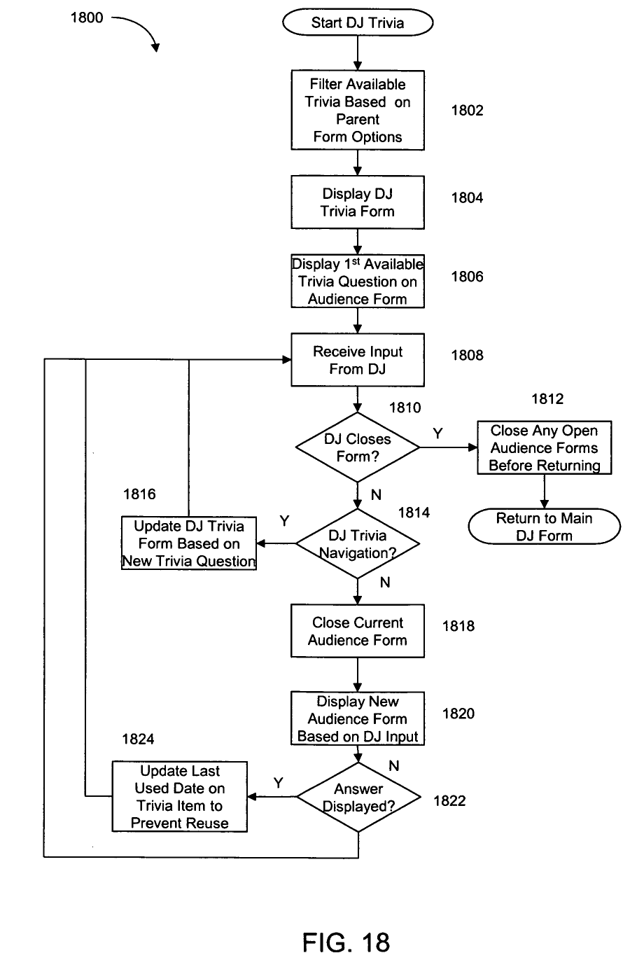

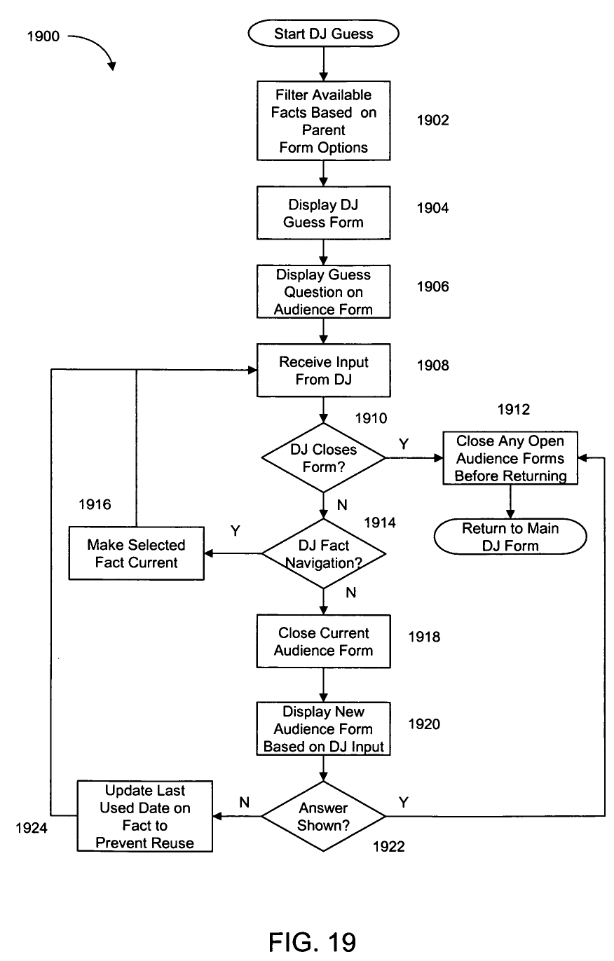

Clicking the artist button 712 initiates the “Start DJ Guess” process as described in FIG. 19. The “Start DJ Guess” process flow is also automatically started when a new song is played if the song attribute for guess the artist is set to “Y”. Clicking the trivia button 714 initiates the “Start DJ Trivia” process as described in FIG. 18.

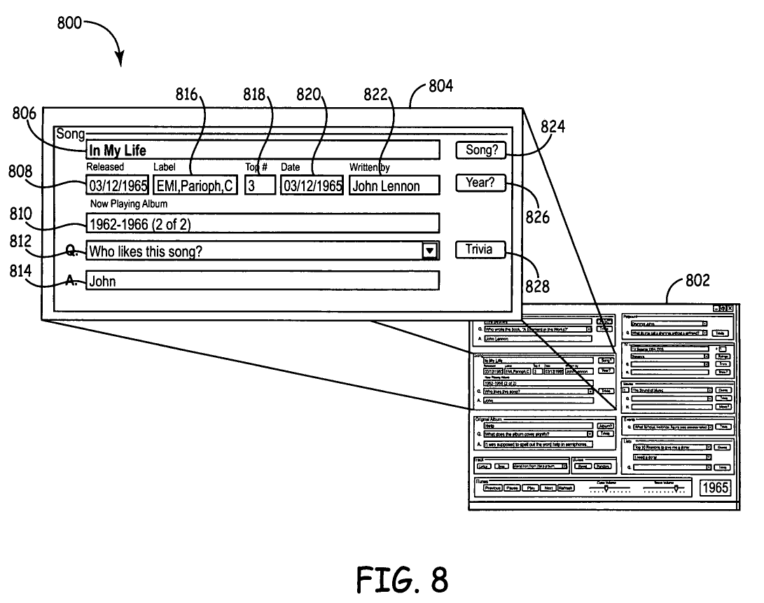

FIG. 8 is a pictorial diagram exemplifying GUI controls within the song section 804 of the DJ console form 802. The song name text box 806 derives the value of its contents from song title information exposed through communication with the media player program 122. The released date text box 808, label text box 816, top # text box 818, top position date text box 820 and written by text box 822 derive their values from a matching song record within the song table 314 from the trivia database 202 based on matching a compressed version of the artist name and a compressed version of the song name provided by the media player with the compressed artist name and compressed song name stored on the trivia database 202. If the match is unsuccessful, the derived text box values are blank. The now playing album text box 810 derives the value of its contents from the current album information exposed through communication with the media player program 122. The song trivia drop down combo box 12 contains all currently available trivia questions directly related to the song shown in the song name text box 806 as determined by the currently playing song. The background song trivia data source is filtered based on a matching unique song ID and last used date/time more than 24 hours old. The answer reflected in the song trivia answer text box 814 is derived from the current selection in the song trivia drop down combo box 812. The DJ may change the selection with the artist trivia drop down combo box 812 at any time assuming more than one selection is available based on the filtered data. Changes to the song trivia drop down combo box 812 cause an immediate change to the contents of the song trivia answer text box 814.

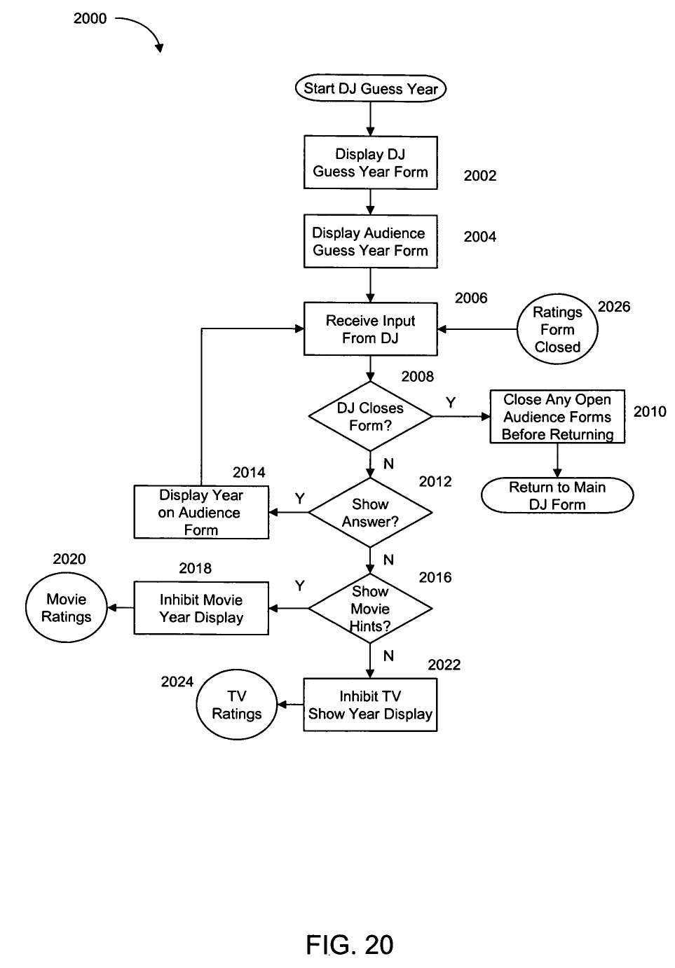

Clicking the song button 824 initiates the “Start DJ Guess” process as described in FIG. 19. The “Start DJ Guess” process flow is also automatically started when a new song is played if the song attribute for guess the song is set to “Y”. Clicking the year button 826 initiates the “Start DJ Guess Year” process as described in FIG. 20. Clicking the trivia button 828 initiates the “Start DJ Trivia” process as described in FIG. 18.

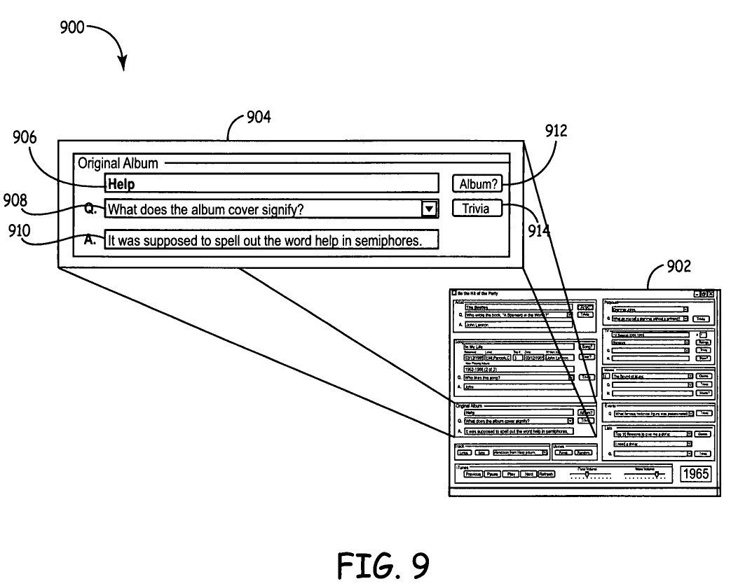

FIG. 9 is a pictorial diagram exemplifying GUI controls within the original album section 904 of the DJ console form 902. The album name text box 906 derives its value from a matching song record within the song table 314 from the trivia database 202 based on matching a compressed version of the artist name and a compressed version of the song name provided by the media player with the compressed artist name and compressed song name stored on the trivia database 202. If the match is unsuccessful, the derived text box values are blank. The album trivia drop down combo box 908 contains all currently available trivia questions directly related to the album shown in the original album name text box 906 as determined by the currently playing song. The background album trivia data source is filtered based on a matching unique album ID and last used date/time more than 24 hours old. The answer reflected in the album trivia answer text box 910 is derived from the current selection in the album trivia drop down combo box 908. The DJ may change the selection with the album trivia drop down combo box 908 at any time assuming more than one selection is available based on the filtered data. Changes to the album trivia drop down combo box 908 cause an immediate change to the contents of the album trivia answer text box 910.

Clicking the album button 912 initiates the “Start DJ Guess” process as described in FIG. 19. Clicking the trivia button 914 initiates the “Start DJ Trivia” process as described in FIG. 18.

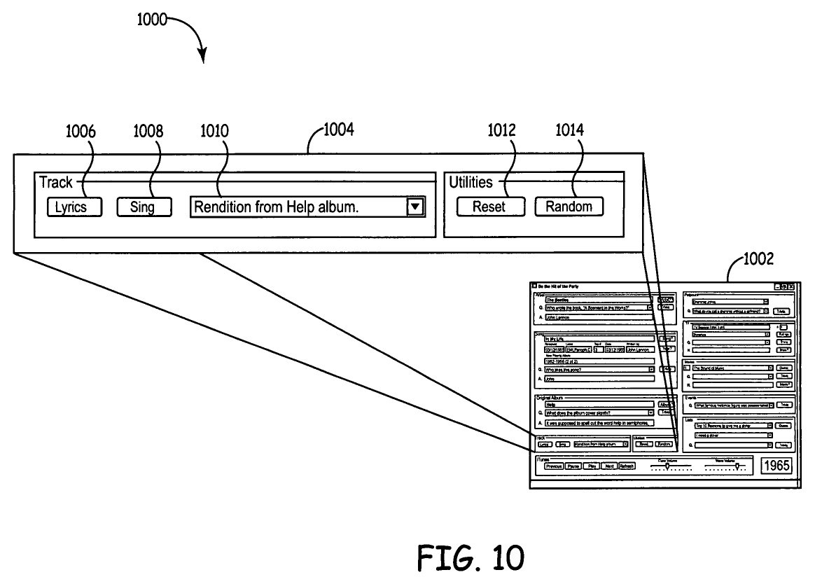

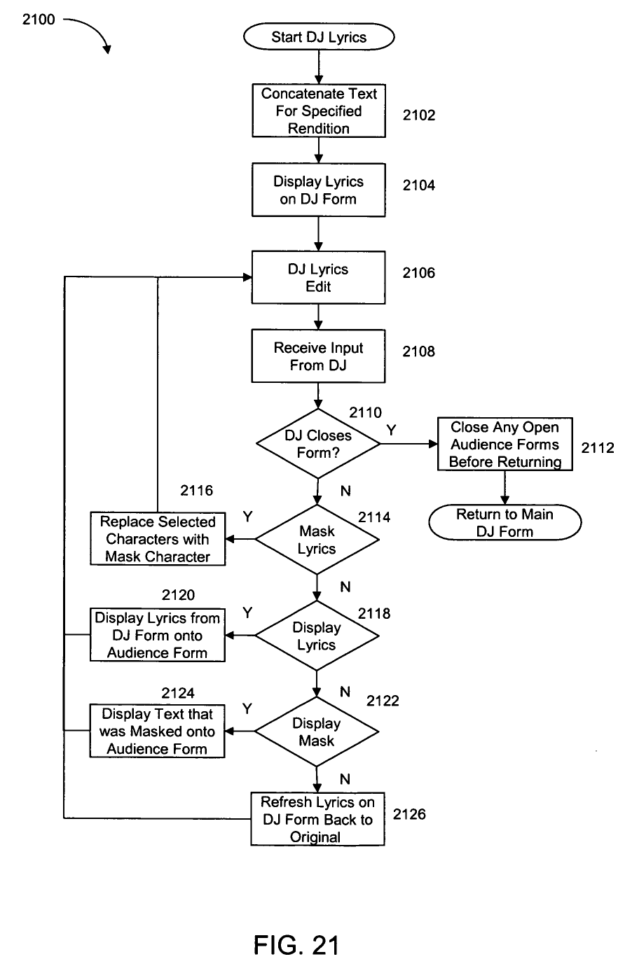

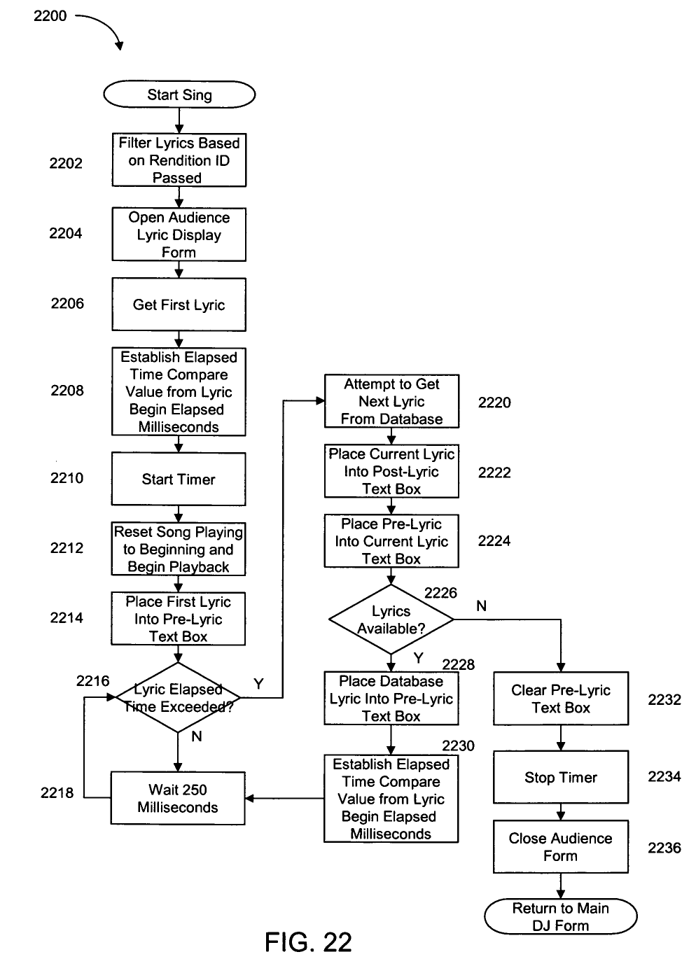

FIG. 10 is a pictorial diagram exemplifying GUI controls within the track and utilities section 1004 of the DJ console form 1002. The rendition description drop down combo box 1010 derives its list of value using the unique song ID from a matching song record within the song table 314 from the trivia database 202 based on matching a compressed version of the artist name and a compressed version of the song name provided by the media player with the compressed artist name and compressed song name stored on the trivia database 202. If the match is unsuccessful, the combo box is empty. Clicking the lyrics button 1006 initiates the “Start DJ Lyrics” process as described in FIG. 21. Clicking the sing button 1008 initiates the “Start DJ Sing” process as described in FIG. 22.

Clicking the reset button 1012 calls a stored procedure within the trivia database 202 resetting the last used date on all trivia questions within trivia 302 table and resetting the last used date on all facts within the artist fact 310 table, song fact 316 table, album fact 326 table, TV show fact 332 table, and movie fact 338 table. Resetting these last used dates makes all trivia and facts immediately available to the current game session.

Clicking the random button 1014 cycles through the current play list within the media player and updates the grouping field with a random number between 1 and 10 times the number of songs in the play list. Once randomized, the media player supports sorting the play list based on the content of the grouping field. Unlike random song sequencing with the media player itself, storing the randomized sequence in the grouping field facilitates restarting the trivia session after system shut down or inadvertent navigation within the media player itself rather than through the trivia program 120.

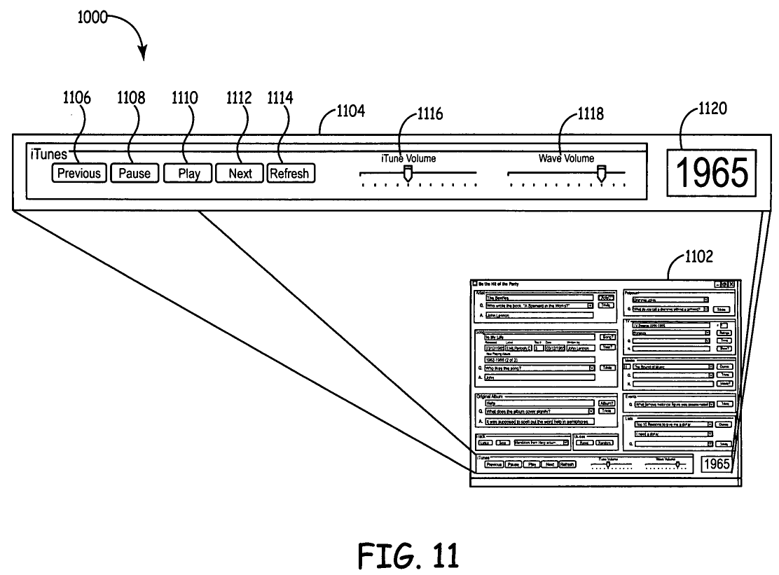

FIG. 11 is a pictorial diagram illustrating the controls within the iTunes section 1104 of the DJ console form 1102. The previous button 1106 causes the media player to skip to the previous selection. The pause button 1108 causes the media player to pause the currently playing selection. The play button 1110 causes the media player to play the current song. The next button 1112 causes the media player to skip to the next song. The iTunes volume control 1116 adjusts the volume on the underlying media player. The wave volume control 1118 adjusts the wave volume on the computer. The displayed year field 1120 reflects the release year derived from a matching song record within the song table 314 from the trivia database 202 based on matching a compressed version of the artist name and a compressed version of the song name provided by the media player with the compressed artist name and compressed song name stored on the trivia database 202. If the match is unsuccessful, the release year is derived from year within the media player song metadata associated with the currently playing song.

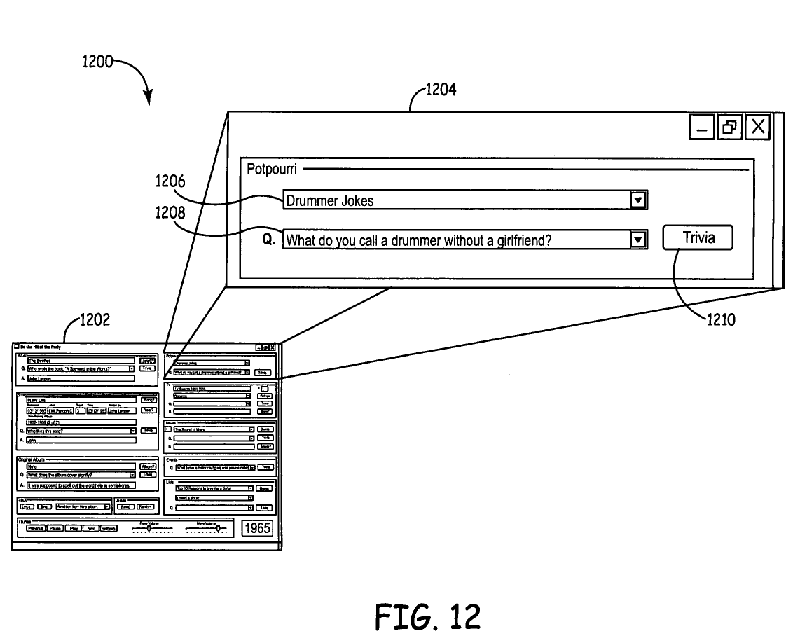

FIG. 12 is a pictorial diagram exemplifying GUI controls within the potpourri section 1204 of the DJ console form 1202. The potpourri category drop down combo box 1206 derives its list of values directly from the category 346 table within the trivia database 202. The category trivia question drop down combo box 1208 derives its list of values from the category trivia 348 table within the trivia database 202. It is filtered based on the current selection within the potpourri category drop down combo box 1206 and based on a matching unique album ID and last used date/time more than 24 hours old. Changes to the selected item within the category drop down combo box 1206 are immediately reflected in the category trivia question drop down combo box 1208 contents. Clicking the trivia button 1210 initiates the “Start DJ Trivia” process as described in FIG. 18.

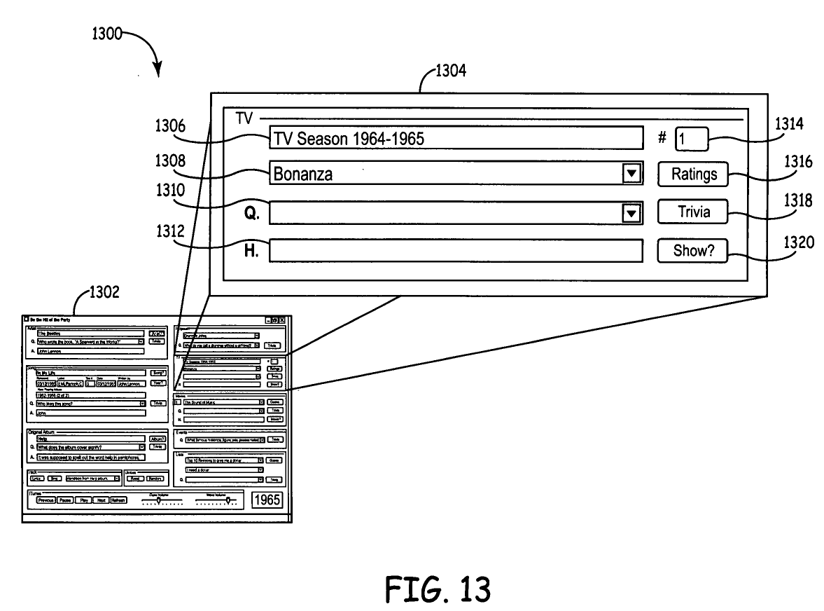

FIG. 13 is a pictorial diagram illustrating the controls within the TV section 1304 of the DJ console form 1302. The TV season text box 1306 derives its value based on the release date associated with matched song record within the song table 314 from the trivia database 202 based on matching a compressed version of the artist name and a compressed version of the song name provided by the media player with the compressed artist name and compressed song name stored on the trivia database 202. If the release date of the associated song derived from the trivia database is a complete date, the TV season is the associated TV season based on a September through August TV year. If the release date of the associated song derived from the database is a year only, it is used as the beginning year in the TV season.

The TV show drop down combo box 1308 derives its contents from the associated TV show chart 356 table and TV show 330 table as filtered for the TV Season displayed in text box 1306. The Rating number text box 1314 derives it value based on the chart position of the currently selected TV show within the TV show drop down combo box 1308. The TV show trivia drop down combo box 1310 derives is list of values based on the currently selected TV show in the TV show combo box 1308 and based on last used date/time being more than 24 hours old. The TV show hint drop down combo box 1312 derives its list of values based on the currently selected TV show in the TV show combo box 1308 and based on last used date/time being more than 24 hours old. A change in the selected value of the TV show combo box 1308 results in immediate corresponding changes to both TV show trivia drop down combo box 1310 and TV show hint drop down combo box 1312.

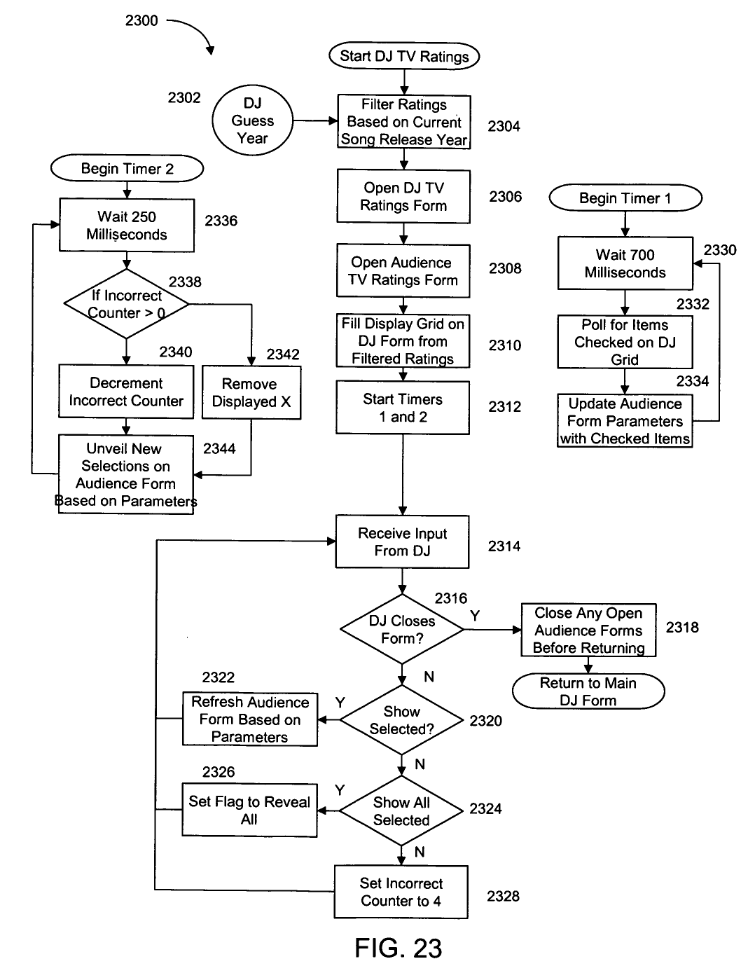

Clicking the TV ratings button 1316 initiates the “Start DJ TV Ratings” process as described in FIG. 23. Clicking the Trivia button 1318 initiates the “Start DJ Trivia” process as described in FIG. 18. Clicking the show button 1320 initiates the “Start DJ Guess” process as described in FIG. 19.

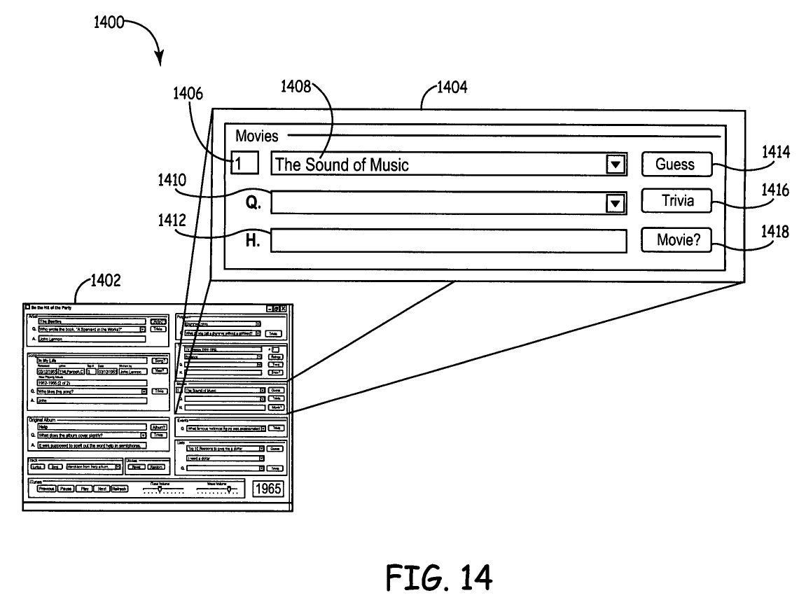

FIG. 14 is a pictorial diagram exemplifying GUI controls within the movies section 1404 of the DJ console form 1402. The movie name drop down combo box 1408 derives its list of values from the movie 336 table within the trivia database 202 as filtered based on the value of the current release year 1120. The contents of the movie name combo box 1408 are sorted in descending order based on movie ranking as established by US gross receipts. The movie ranking text box 1406 derives its value based on the movie ranking within the current release year of the movie currently selected in the movie name drop down combo box 1408. Changes to the currently selected movie in the movie name drop down combo box 1408 are immediately reflected by a corresponding change in the value of the movie ranking text box 1406. The movie trivia drop down combo box 1410 derives is list of values based on the currently selected movie in the movie name drop down combo box 1408 and based on last used date/time being more than 24 hours old. The movie hint drop down combo box 1412 derives its list of values based on the currently selected movie in the movie drop down combo box 1408 and based on last used date/time being more than 24 hours old. A change in the selected value of the movie drop down combo box 1408 results in immediate corresponding changes to both the movie trivia drop down combo box 1410 and the movie hint drop down combo box 1412.

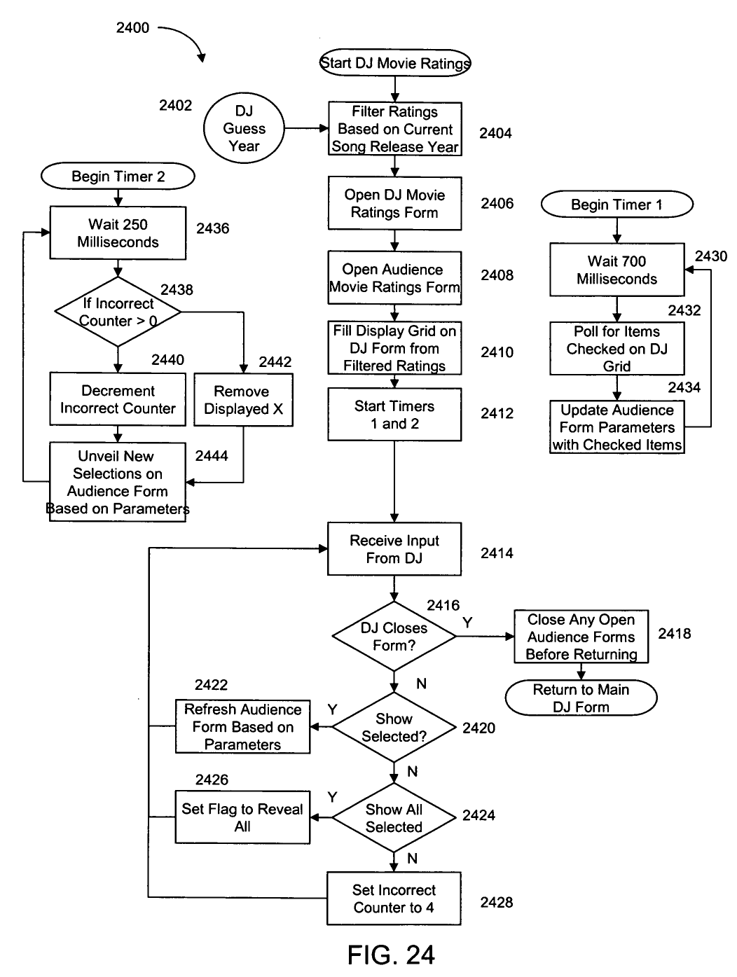

Clicking the guess button 1414 initiates the “Start DJ Movie Ratings” process as described in FIG. 24. Clicking the Trivia button 1416 initiates the “Start DJ Trivia” process as described in FIG. 18. Clicking the movie button 1418 initiates the “Start DJ Guess” process as described in FIG. 19.

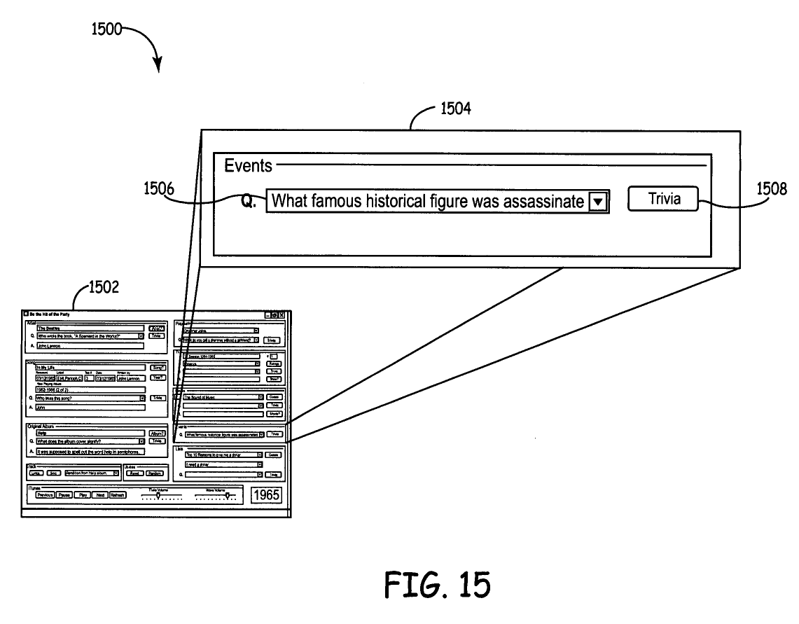

FIG. 15 is a pictorial diagram exemplifying GUI controls within the events section 1504 of the DJ console form 1502. The event trivia drop down combo box 1506 derives its list of values from the historical event trivia 344 and trivia 302 tables within the trivia database 202 as filtered based on the value of the current release year 1120 and based on a last used date/time being more than 24 hours old.

Clicking the trivia button 1508 initiates the “Start DJ Trivia” process as described in FIG. 18.

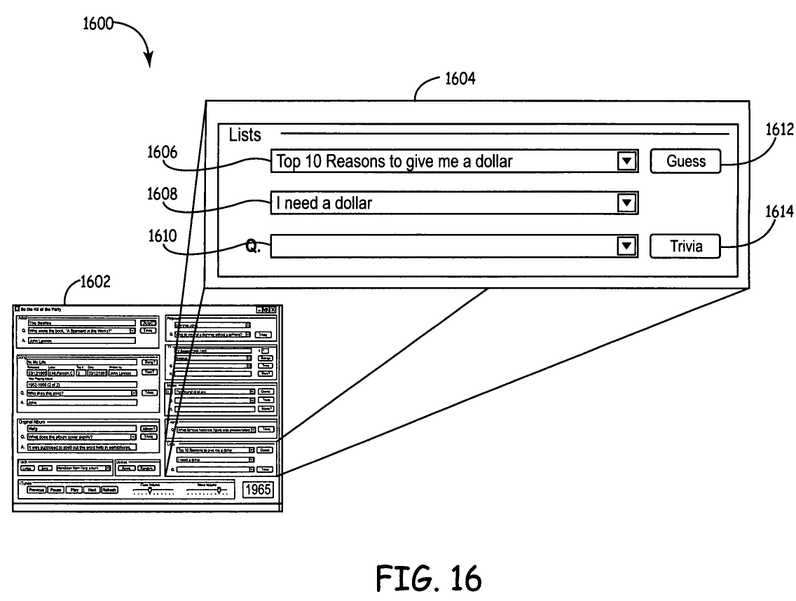

FIG. 16 is a pictorial diagram exemplifying GUI controls within the lists section 1604 of the DJ console form 1602. The list description drop down combo box 1606 derives its contents from the List 350 table within the trivia database 202. The list item drop down combo box 1608 derives its contents from the list item 352 table within the trivia database 202 as filtered based on the list ID associated with the currently selected list in the list description drop down combo box 1606. Changes to the currently selected list in the list description drop down combo box 1606 are immediately reflected with changes to the contents of the list item drop down combo box 1608. The list item trivia question drop down combo box 1610 derives its list of values from the list item trivia 354 and trivia 302 tables within the trivia database 202 as filtered based on the list item ID of the currently selected list item within the list item drop down combo box 1608 and based on a last used date/time being more than 24 hours old. Changes to the currently selected item in the list item drop down combo box 1608 are immediately reflected with changes to the contents of the list item trivia question drop down combo box 1610.

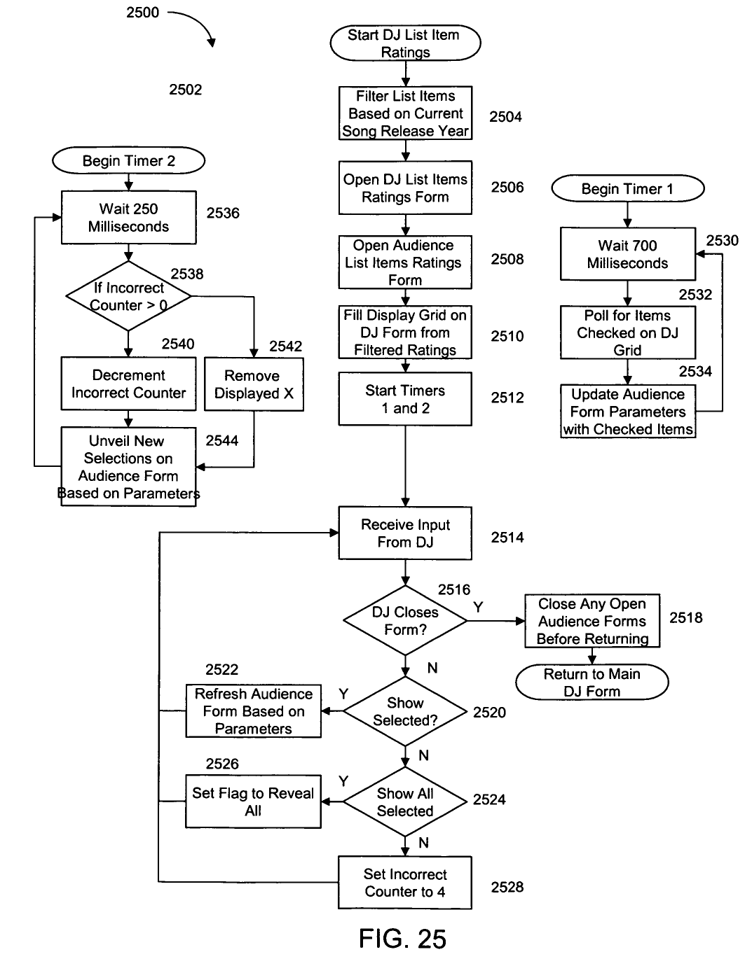

Clicking the guess button 1612 initiates the “Start DJ List Item Ratings” process as described in FIG. 25. Clicking the Trivia button 1614 initiates the “Start DJ Trivia” process as described in FIG. 18.

As is evident from FIGS. 6-16, the GUI may be used to provide trivia items and/or hints to a host that are grouped as classes associated with recording attributes. The classes may be displayed as a catalog in the GUI. The GUI further provides, in this embodiment, a plurality of classes. The host may choose between classes and choose one or more items from a catalog of trivia and/or hints in the class. The choice of a plurality of classes provides for flexibility in a hosted game because, for instance, the host may choose classes suited to the viewers. In some embodiments, the classes for the GUI are the same as specific tables used in the trivia database (as in tables 308, 314, 324, 330, 336, 342, 346, and/or 352), which provides significant efficiencies for loading, making, reviewing, or updating the appropriate database. Further, the application itself may be directed to hosts (persons) with different interests such that using classes leads to efficiencies in providing trivia and/or hints suited to the hosts. Accordingly, some embodiments are directed to providing a host, optionally by using a GUI, with a plurality of catalogs of information (e.g., hints and/or trivia), a plurality of information catalogs, or a plurality of information catalogs in one or more classes. The information may have, for instance, between 1 and about 500 items, between 1 and about 500 catalogs, and between 1 and about 500 classes, or some combination thereof; artisans will immediately appreciate that all the ranges and values within the explicitly stated ranges are contemplated, e.g., at least about 10, at least about 50, at least about 100, between about 10 to about 100 or between about 5 to about 221. The power and advantages of the systems described herein support intaking, using, processing, and presenting large amounts of information that is not suited to conventional processes. In some embodiments, a class will have access to a database of predetermined trivia associated with that class and to a database or table of hints, with both hints and trivia being associated with an attribute of a recording. Such hint/trivia databases/tables may be provided on separate or the same computing media and in separate or the same software application.

FIG. 17 is a table diagram describing each of the primary events accounted for within program logic supporting the main DJ console form 702 in a particular embodiment. As described herein, content may be derived from an attribute-bearing media library, e.g., ITUNES, or other source.
The new song event 1702 includes the following processing steps.
   1. Initialize variables.
   2. Obtain information from media player program 122.
   3. Attempt to find corresponding artist and song with trivia database 202.
   4. Establish global variable values based on attributes of matched song from database.
   5. If no matching song is found, establish global release year based on year in media player song metadata.
   6. Establish TV Season based on specific song release date or based on release year only if a complete song release date is not available.
   7. Establish data filters for form data sources based on attributes of currently playing song.
The application close event 1704 includes the following processing steps.
   1. Close the application.
The artist trivia question change event 1708 includes the following processing steps.
   1. Re-set global variable with unique identifier for current trivia question.
The artist button clicked event 1710 includes the following processing steps.
   1. Create a new form instance for the guess artist form.
   2. Show the new form on the DJ console as a dialogue.
The artist trivia button clicked event 1712 includes the following processing steps.
   1. Create a new form instance for the DJ trivia form.
   2. Set the form trivia type to artist.
   3. Set the global artist identifier value to the current artist identifier.
   4. Set the form index position to the index position for the currently selected artist trivia item within the combo box.
   5. Show the new form on the DJ console as a dialogue.
   6. Refill artist trivia table adapter to exclude any trivia items used.
The song trivia question change event 1716 includes the following processing steps.
   1. Re-set global variable with unique identifier for current trivia question. The song button clicked event 1718 includes the following processing steps.
   1. Create a new form instance for the guess song form.
   2. Show the new form on the DJ console as a dialogue.
The song year button clicked event 1720 includes the following processing steps.
   1. Create a new form instance for the guess year form.
   2. Show the new form on the DJ console as a dialogue.
The song trivia button clicked event 1722 includes the following processing steps.
   1. Create a new form instance for the DJ trivia form.
   2. Set the form trivia type to song.
   3. Set the global song identifier value to the current song identifier.
   4. Set the form index position to the index position for the currently selected song trivia item within the combo box.
   5. Show the new form on the DJ console as a dialogue.
   6. Refill song trivia table adapter to exclude any trivia items used.
The album trivia question change event 1726 includes the following processing steps.
   1. Re-set global variable with unique identifier for current trivia question.
The album button clicked event 1728 includes the following processing steps.
   1. Create a new form instance for the guess album form.
   2. Show the new form on the DJ console as a dialogue.
The album trivia button clicked event 1730 includes the following processing steps.
   1. Create a new form instance for the DJ trivia form.
   2. Set the form trivia type to album.
   3. Set the global album identifier value to the current album identifier.
   4. Set the form index position to the index position for the currently selected album trivia item within the combo box.
   5. Show the new form on the DJ console as a dialogue.
   6. Refill album trivia table adapter to exclude any trivia items used.
The lyrics button clicked event 1732 includes the following processing steps.
   1. Concatenate all individual text items for the selected rendition into a single text value.
   2. Create a new form instance for the DJ lyrics form.
   3. Set the value of the form lyrics variable to the concatenated text.
   4. Show the new form on the DJ console as a dialogue.
The sing button clicked event 1734 includes the following processing steps.
   1. Create a new form instance for the sync text form.
   2. Set the form title.
   3. Set the form song identifier value.
   4. Set the form rendition identifier value.
   5. Show the new form on the audience display.
The reset clicked event 1738 includes the following processing steps.
   1. Create date/time value equal to current date/time minus 7 days
   2. Confirm DJ want to reset last used dates.
   3. Change the cursor style to hourglass.
   4. Open database connection.
   5. Call stored procedure to reset dates with passed parameter computed date/time value for current date/time minus 7 days.
   6. Close database connection.
   7. Fill table adapters based on re-set values.
   8. Change cursor style back to arrow.
The random clicked event 1740 includes the following processing steps.
   1. Create a new form instance for the random form.
   2. Show the new form on the DJ console as a dialogue.
The iTunes previous button clicked event 1742 includes the following processing steps.
   1. Fire the ITUNES SDK PreviousTrack event.
   2. Fire the NewSong 1702 event.
The iTunes pause button clicked event 1744 includes the following processing steps.
   1. Fire the ITUNES SDK Pause event.
The iTunes play button clicked event 1746 includes the following processing steps.
   1. Fire the ITUNES SDK Play event.
The iTunes next button clicked event 1748 includes the following processing steps.
   1. Fire the ITUNES SDK NextTrack event.
   2. Fire the NewSong 1702 event.
The iTunes refresh button clicked event 1750 includes the following processing steps.
   1. Fire the NewSong 1702 event.
The iTunes ITUNES volume adjusted event 1752 includes the following processing steps.
   1. Set the ITUNES volume to the trackbar value multiplied by 10.
The iTunes wave volume adjusted event 1754 includes the following processing steps.
   1. Calculate the volume being set.
   2. Set the same volume for both the left and right channels.
   3. Set the wave out volume.
The potpourri category change event 1756 includes the following processing.
   1. Set filter on data binding source based on currently selected item category ID and last used date/time more than 24 hours old.
The potpourri trivia button clicked event 1760 includes the following processing.
   1. Create a new form instance for the DJ trivia form.
   2. Set the form trivia type to potpourri.
   3. Set the global category description to the current category description.
   4. Set global trivia identifier to trivia identifier from currently selected trivia item within combo box.
   5. Set the global category identifier to the current category identifier value.
   6. Set the form index position to the index position for the currently selected album trivia item within the combo box.
   7. Show the new form on the DJ console as a dialogue.
   8. Refill potpourri trivia table adapter to exclude any trivia items used.
The TV show change event 1762 includes the following processing.
   1. If a value is selected, set filters for TV show trivia data binding source and TV show fact data binding source based on the currently selected TV show ID and last used date/time more than 24 hours old.
   2. If no value is selected, set filters for TV show trivia data binding source and TV show fact data binding source to 0.
The TV show ratings button clicked event 1766 includes the following processing.
   1. Create a new form instance for the TV ratings form.
   2. Set form text to TV season description.
   3. Show the new form on the DJ console as a dialogue.
The TV show trivia button clicked event 1768 includes the following processing.
   1. Set global TV show identifier to value derived from TV show combo box selected value.
   2. Set global TV show name to TV show combo box text for selected item.
   3. Set global TV show ranking based on TV show ranking text box value.
   4. Create a new form instance for the DJ trivia form.
   5. Set the form trivia type to tv.
   6. Set the form index position to the index position for the currently selected TV trivia item within the combo box.
   7. Show the new form on the DJ console as a dialogue.
   8. Refill TV trivia table adapter to exclude any trivia items used.
The TV show, show button clicked event 1770 includes the following processing.
   1. Set global TV show identifier to value derived from TV show combo box selected value.
   2. Set global TV show name to TV show combo box text for selected item.
   3. Set global TV show ranking based on TV show ranking text box value.
   4. Create a new form instance for the Guess TV Show DJ form.
   5. Show the new form on the DJ console as a dialogue.
The movie change event 1772 includes the following processing.
   1. If a value is selected, set filters for movie trivia data binding source and movie fact data binding source based on the currently selected movie ID and last used date/time more than 24 hours old.
   2. If no value is selected, set filters for movie trivia data binding source and movie fact data binding source to 0.
The movie guess button clicked event 1776 includes the following processing.
   1. Create a new form instance for the Movie DJ form.
   2. Show the new form on the DJ console as a dialogue.
The movie trivia button clicked event 1778 includes the following processing.
   1. Set global movie identifier to value derived from movie combo box selected value.
   2. Set global movie title to movie combo box text for selected item.
   3. Set global movie ranking based on movie ranking text box value.
   4. Create a new form instance for the DJ trivia form.
   5. Set the form trivia type to movie.
   6. Set the form index position to the index position for the currently selected movie item within the combo box.
   7. Show the new form on the DJ console as a dialogue.
   8. Refill movie trivia table adapter to exclude any trivia items used.
The movie button clicked event 1780 includes the following processing.
   1. Set global movie identifier to value derived from movie combo box selected value.
   2. Set global movie title to movie combo box text for selected item.
   3. Set global movie ranking based on movie ranking text box value.
   4. Create a new form instance for the Guess movie DJ form.
   5. Show the new form on the DJ console as a dialogue.
The events trivia button clicked event 1784 includes the following processing.
   1. Create a new form instance for the DJ trivia form.
   2. Set the form trivia type to event.
   3. Set the form index position to the index position for the currently selected event item within the combo box.
   4. Show the new form on the DJ console as a dialogue.
   5. Refill event trivia table adapter to exclude any trivia items used.
The list change event 1786 includes the following processing.
   1. Set the filter for the list item binding source based on the current release year and the selected list.
   2. Set the filter for the list item trivia based on the currently selected list item and last used date/time more than 24 hours old.
The list item change event 1788 includes the following processing.
   1. Set the filter for the list item trivia based on the currently selected list item and last used date/time more than 24 hours old.
The list item guess button clicked event 1792 includes the following processing.
   1. Set global list name to value of currently selected text in list combo box.
   2. Set global list identifier to selected value of list combo box.
   3. Create a new form instance for the DJ list form.
   4. Show the new form on the DJ console as a dialogue.
The list item trivia button clicked event 1794 includes the following processing.
   1. Create a new form instance for the DJ trivia form.
   2. Set the form trivia type to list item.
   3. Set the form index position to the index position for the currently selected list item within the combo box.
   4. Show the new form on the DJ console as a dialogue.
   5. Refill list item trivia table adapter to exclude any trivia items used.
FIG. 18 is a flow diagram illustrating the flow for the DJ trivia process. Control is passed from the main DJ form to this form and process when the DJ clicks any of the trivia buttons on the main DJ form.

Block 1802 includes logic to fill data adapters for all relevant trivia forms. It then establishes data filters based on the initiating class of trivia passed from the main DJ form. It also associates each of the controls on the form to a specific data binding source based on the initiating class of trivia passed from the main DJ form.

At block 1804 the DJ trivia form is displayed on the DJ console and is populated based on the selected trivia item passed from the main DJ form.

At block 1806 the audience form is populated based on currently selected trivia item from the DJ trivia form. The form displays the trivia question on the audience display device 112 but does not display the answer, hints and multiple choice values that are visible only to the DJ on the DJ console 108.

At block 1808 the DJ provides input on the DJ console by selecting one of the buttons available on the DJ trivia form. The DJ is given discretion to select and display a hint, show multiple choice options, show the answer, scroll through available trivia questions related to the current trivia class instance or close the form and return to the main DJ form.

At decision block 1810 the application detects whether the DJ has opted to close the form either by clicking the close button or by clicking the Windows standard red X in the top right hand corner of the form.

At block 1812 the form checks to see if any audience forms are open. If so, they are closed before control is returned to the main DJ form. Those skilled in the art will appreciate that one controlling form is responsible for all DJ interaction and audience forms appear and disappear automatically without requiring the DJ to change focus to a second form on a second display.

Decision block 1814 tests to see whether or not the DJ has selected a new trivia question by navigating forward or backward through available trivia questions using navigation buttons. If so, block 1816 refreshes the controls on the DJ form with attributes of the newly selected trivia question. If not, any currently open audience form is closed as shown in block 1818 and a new one is displayed based on DJ selection as shown in block 1820. The audience trivia form is comprised of three primary form text boxes. One includes information relevant to the current trivia class instance. This may include the artist, song title and release year for currently playing song. It may include the year and television show name for TV trivia, etc. A second text box displays the trivia question. A third text box is used to display the current hint, multiple choice selections, the answer to the trivia question or the answer to the trivia question in the context of the multiple choice options provided. An alternative audience trivia form replaces the third text box with an image box used to present an image of relevance to the trivia question. The DJ controls which variation of the audience form displays and can switch from one to the other with the click of a button. The audience form is displayed using very large text fonts for easy viewing even in a very large room.

Decision block 1822 tests to see whether the DJ opted to show the answer to the audience. This typically occurs when someone guesses the correct answer or if no one is able to guess the correct answer. It is important to display the correct answer to the entire audience even if someone guesses the correct answer because frequently some people in the audience cannot hear the correct answer being verbalized. This is also done as a courtesy to the hearing impaired. If the answer was displayed to the audience block 1824 illustrates how the trivia question is updated to eliminate it from the current pool of trivia questions. This prevents trivia duplication within a single trivia event. This is especially important given the free association nature of the trivia in this game which may expose the same trivia question under many different situations. Trivia related to year, for example, will be exposed each time a song released during that year is played. Those skilled in the art will appreciate the manner in which duplicate presentation of the same trivia question has been prevented. Control is then passed back to block 1808 to await the next input from the DJ.

FIG. 19 is a flow diagram illustrating the flow for the a of hosted guess processes. Control is passed from the main host (e.g., a DJ) form to one of these forms and processes when the DJ clicks one the buttons on the main DJ form associated with guessing the identity of something using hints including guess the artist, guess the song, guess the album, guess the TV show and guess the movie.

Block 1902 illustrates that a data filter is set to include only facts/hints associated to the specific entity being guessed by using the unique identifier for that entity passed with a global variable. The filter is also set to exclude facts/hints that have already been used within the last 24 hours. Once the filter is set, the form is populated and displays a list of available facts/hints that the DJ may choose between as shown in block 1904.

Block 1906 illustrates how the first available hint/fact is automatically displayed on an audience form on the audience display device 112. Automatic display of the first hint prior to DJ selection keeps the game moving at a fast pace, which is an advantage of the system.

Block 1908 illustrates that the DJ provides input based on a limited number of choices. The DJ can close the form, select another fact/hint from a list, display another fact/hint to the audience or display the identity of the item being guessed to the audience.

Decision block 1910 tests to see if the DJ has closed the form. If so, logic automatically closes any open audience-displayed forms at block 1912 and closes the DJ guess form before returning control back to the main DJ form.

Decision block 1914 test to see whether or not the DJ has navigated between facts/hints displayed in a drop down combo box. If so, it makes the selected fact the current fact and returns back to block 1908 to await additional input from the DJ. If not, any currently displayed audience form is closed at block 1918 and a new audience display form is presented at block 1920. The audience display form includes two text boxes. One includes a general audience instruction such as “Name that Artist!” The other includes the currently selected fact/hint or the answer. The audience form is displayed using very large text fonts for easy viewing even in a very large room.

Decision block 1922 tests to see whether the answer was shown to the audience. If so, the audience form is closed at block 1912, the DJ guess form is closed and control returns to the main DJ form. If not, a fact/hint had been displayed to the audience. The fact/hint is updated with the current date/time to prevent it from being used again for 24 hours or until the DJ resets all facts/hints and trivia. Control returns to block 1908 to await the next input from the DJ.

FIG. 20 is a flow diagram illustrating the flow for a hosted (e.g., DJ) process for guessing the year of the song currently playing (i.e., playing in real time). Control is passed from the main DJ form to this form and process when the DJ clicks the button for guess the year on the main DJ form.

Block 2002 illustrates the display of the DJ form that includes three buttons. Immediately after the DJ form is displayed the audience form is displayed at block 2004 prompting the audience to guess the year. The DJ form includes three buttons and the standard Windows form closing option.

Decision block 2008 determines whether or not the DJ has closed the form using the standard Windows X button. If so, control is passed to block 2010 closing any open audience display forms and the DJ guess the year form. If not, decision block 2012 determines whether or not the DJ opted to show the audience the answer. If so, any currently open audience display form is closed and the correct year is displayed on a new audience display form at 2014. Control then passes back to block 2006 and awaits input from the DJ. If not, decision block 2016 determines whether the DJ clicked the button to display movie hints. If so, block 2018 inhibits the display of the movie year and passes control to the movie ratings process 2020 FIG. 24. Otherwise, the DJ has clicked the button to display TV hints. Block 2022 inhibits the display of the TV show year and passes control to the TV ratings process 2024 FIG. 23. The system inhibits the display of the year for both movie ratings and TV ratings by creating the appropriate form instance and setting a public parameter dictating that the form title text box does not include the year. The same forms for movie and TV ratings can be called from the main DJ form without setting the parameter to inhibit year display.

Transfer of control block 2026 shows that control returns when either the movie ratings process or TV ratings process ends.

FIG. 21 is a flow diagram illustrating the flow for a DJ process for editing and displaying song lyrics. Control is passed from the main DJ form to this form and process when the DJ clicks the button for lyrics on the main DJ form.

When control is passed to the form, individual lyric stanzas are obtained from the database and concatenated together to form on large text block at block 2102. A global variable identifying the song rendition provides the basis for capturing the lyric stanzas. The concatenated text block is then displayed to the DJ on the DJ form at block 2104. The DJ can then edit the lyrics at block 2106 and make a button selection as received at block 2108. Editing options for the DJ include modifying the displayed text and selecting a portion of the text to be masked.

If the DJ clicks the standard Windows X button to close the form, the action is detected at decision block 2110 and control passes to block 2112. At block 2112, any open audience display forms are closed along with the current DJ form and control is passed back to the main DJ form.

If the DJ clicks the button to mask lyrics as detected at decision block 2114, control passes to block 2116. At block 2116, any selected text characters are replaced with the “*” character on within the text box on the DJ form. Character replacement is accomplished by obtaining the position and length of the currently selected text within the text block. A loop is then utilized to inspect each character individually. Spaces and new line characters are preserved while all other characters are replaced with the “*” characters. Preserving spaces and new line characters is an important logic step if the masked characters are going to be used to prompt the audience to guess part of the song lyrics. Without this preservation, the audience has no idea how many individual words are in the stanza they are trying to identify. Those skilled in the art will appreciate the importance of this subtle element when the game is played. Control then passes back to block 2106 where the DJ may edit the lyrics or proceed to click another button at block 2108.

If the DJ clicks the button to display the lyrics as detected at decision block 2118, control passes to block 2120. At block 2120, any open audience display form is closed and a new audience display form is presented. The new audience display form shows the text as it currently appears on the DJ form. If characters have been masked, those characters are shown masked on the audience display form as well. Control then passes back to block 2106 where the DJ may edit the lyrics or proceed to click another button at block 2108.

If the DJ clicks the button to display the mask as detected at decision block 2122, control passes to block 2124. At block 2124, any open audience display form is closed and a new audience display form is presented. The new audience display form shows only the text that was previously masked. The masked characters are revealed in their original form. Control then passes back to block 2106 where the DJ may edit the lyrics or proceed to click another button at block 2108.

If the DJ clicks the button to reset the text as detected by the “N” branch of the decision block 2122, control passes to block 2126. At block 2126, the text box is re-filled from the original concatenated text on the DJ form. Control then passes back to block 2106 where the DJ may edit the lyrics or proceed to click another button at block 2108.

FIG. 22 is a flow diagram illustrating a flow for process called when a sing button is clicked on the main DJ form. The sing process can be used to display song lyrics in synchronization with the song playback. It is not, however, limited to just a display of song lyrics. It can be used to display any text in synchronization with the playback of a song. It can, for example, be used to display trivia questions and answers related to the lyrics. It can be used to display interesting lyric-related facts. It can be used to display satirical lyrics. Whatever text has been recorded for the specific rendition selected on the main DJ form, is utilized by this form along with its timings as shown in block 2202. This form is displayed immediately as an audience display form. There is no intermediate DJ form used for control. This form is also not called as a dialogue. The result is that the DJ can proceed with selection of trivia and hints while this form continues to process in parallel. New dialogue forms triggered by the DJ simply display to the audience and then disappear revealing the fact that this form remains on the audience display and remains in synchronization with the currently playing song.

At block 2204, the audience display form is opened. At block 2206, the first lyric/text stanza is obtained from the database. At block 2208, the elapsed time attribute of the lyric/text stanza is added to the current time in order to establish a comparison time that will trigger the first lyric/text stanza to be placed into the current lyric/text text box. At block 2210 a timer event is started. The timer event is then triggered every 250 milliseconds. At block 2212 the song is reset to the beginning by calling an event on the media player program 122. At block 2214 the first lyric is displayed into the pre-lyric text box on the audience display form.

The audience window has been carefully architected to include a pre-lyric, current lyric and post-lyric text box. The current lyric text box is displayed in the largest font and is the primary audience focus. It displays one lyric/text stanza at a time. The pre-lyric text box previews the upcoming lyric/text for the audience and allows for read-ahead in a sing-along. The post-lyric display shows the previous current lyric and may be useful if an audience member is particularly interested in a lyric/stanza and wants to confirm it or reinforce it in memory. Text moves from the current lyric text box to the post-lyric text box, from the pre-lyric text box to the current lyric text box and from the database to the pre-lyric text box each time a timing threshold is reached. A graphic image is displayed in the current lyric/text text box when instrumental portions of the song are played.

Decision block 2216 represent the decision made every 250 milliseconds to test to see whether or not it is time to change the lyric. Control is passed to block 2218 to wait another 250 milliseconds if the comparison time has not yet been surpassed. If the comparison time has been surpassed, control passes to block 2220.

At block 2220 the program attempts to get another lyric for the rendition from the database. At block 2222, the current lyric text is placed into the post-lyric text box on the audience display form. At block 2224, the pre-lyric text is placed into the current lyric text box on the audience display form. At decision block 2226, a decision is made in terms of whether or not lyric/text is complete for the song. If a lyric/text is available, control passes to block 2228. At block 2228, the available lyric/text is placed into the pre-lyric text box. At block 2230, a new comparison time is established based on the elapsed time attribute for the lyric/text in the current lyric text box. Control then passes to block 2218 where a 250 millisecond wait occurs.

If no more lyrics/text is available, the pre-lyric text box is cleared. The timer is stopped. The audience display form is closed and control returns to the main DJ form.

FIG. 23 is a flow diagram illustrating a flow for a process called when a TV ratings button is clicked on the main DJ form. This process can also be called from the guess the year process as shown by transfer of control block 2302. When called from the guess the year process, the display of the year on the form title text box is inhibited.

At block 2304 the data filter is set to include only TV shows for current release year as determined by the global variable for current release year. At block 2306, the DJ form is opened on the DJ display and the corresponding audience display form is opened at block 2308. At block 2310 the data grid on the DJ form is filled with data from the TV data source. At block 2312 two timers are started. Timer 1 is used to poll the data grid on the DJ form looking for items that have been checked by the DJ. Timer 2 is used to control the display of information on the audience display form. As items are checked by the DJ and identified by Timer 1, variables within the audience display form are set. Timer 2 monitors these values and automatically reveals corresponding items on the audience form as items are checked on the DJ form. This dual timer process prevents the DJ from having to switch focus to the audience form enhancing the continuity of the game.

The Timer 1 process is as follows. At block 2330, a 700 millisecond wait is performed. At block 2332, the system polls the items within the data grid displayed on the DJ form. The TV shows for rows that are checked are placed into public memory variables within the audience display form at block 2334. Control then returns to block 2330.

Timer 2 performs 2 functions. It monitors variables within the audience form and reveals choices as they are selected. It also controls the display of a graphic used to designate an incorrect answer by the audience. Because it is desirable to poll for new updates to the form selections frequently, every 250 milliseconds, and because it is desirable to display the incorrect answer graphic for longer than 250 milliseconds, a counter is used. The Timer 2 process is as follows. At block 2336, a 250 millisecond wait is performed. At decision block 2338 the cycle counter controlling the display of the incorrect choice graphic is examined. It the counter value is greater than zero control passes to block 2340 where the counter is decremented. If the counter value is not greater than zero, the incorrect choice graphic is hidden at block 2342. Control then passes to block 2344. At block 2344, the public variables are examined and choices are revealed to the audience for any variable values set to true by the DJ form. Control then passes back to block 2336.

At block 2314, the DJ form receives input from the DJ. The DJ may opt to close the form using the standard Windows X button. The DJ may select the “Show” button to reset the audience display form. The DJ may select the “Show All” button to reveal all choices on the audience display form. The DJ may select the “Wrong” button triggering the display of the graphic “X” on the audience display form.

At decision block 2316, a test is performed to see if the DJ closed the form. If so, the system closes any open audience display forms at block 2318, closes the DJ form and returns control back to the main DJ form.

At decision block 2320, a test is performed to see if the “Show” button was clicked. If so, the audience display form is reset based on current variable values at block 2322. Control then passes back to block 2314.

At decision block 2324, a test is performed to see if the “Show All” button was clicked. If so, a flag is set by way of a public variable in the audience display form at block 2326. Control passes back to block 2314.

Block 2328 is passed control if the “Wrong” button is clicked. The incorrect counter is set to 4 causing the graphic “X” to be displayed for 4, 250 millisecond cycles of Timer 2. Control then passes back to block 2314.

FIG. 24 is a flow diagram illustrating a flow for a process called when a movie guess button is clicked on the main DJ form. This process can also be called from the guess the year process as shown by transfer of control block 2402. When called from the guess the year process, the display of the year on the form title text box is inhibited.

At block 2404 the data filter is set to include only movies for current release year as determined by the global variable for current release year. At block 2406, the DJ form is opened on the DJ display and the corresponding audience display form is opened at block 2408. At block 2410 the data grid on the DJ form is filled with data from the movie data source. At block 2412 two timers are started. Timer 1 is used to poll the data grid on the DJ form looking for items that have been checked by the DJ. Timer 2 is used to control the display of information on the audience display form. As items are checked by the DJ and identified by Timer 1, variables within the audience display form are set. Timer 2 monitors these values and automatically reveals corresponding items on the audience form as items are checked on the DJ form. This dual timer process prevents the DJ from having to switch focus to the audience form enhancing the continuity of the game.

The Timer 1 process is as follows. At block 2430, a 700 millisecond wait is performed. At block 2432, the system polls the items within the data grid displayed on the DJ form. The movies for rows that are checked are placed into public memory variables within the audience display form at block 2434. Control then returns to block 2430.

Timer 2 performs 2 functions. It monitors variables within the audience form and reveals choices as they are selected. It also controls the display of a graphic used to designate an incorrect answer by the audience. Because it is desirable to poll for new updates to the form selections frequently, every 250 milliseconds, and because it is desirable to display the incorrect answer graphic for longer than 250 milliseconds, a counter is used. The Timer 2 process is as follows. At block 2436, a 250 millisecond wait is performed. At decision block 2438 the cycle counter controlling the display of the incorrect choice graphic is examined. It the counter value is greater than zero control passes to block 2440 where the counter is decremented. If the counter value is not greater than zero, the incorrect choice graphic is hidden at block 2442. Control then passes to block 2444. At block 2444, the public variables are examined and choices are revealed to the audience for any variable values set to true by the DJ form. Control then passes back to block 2436.

At block 2414, the DJ form receives input from the DJ. The DJ may opt to close the form using the standard Windows X button. The DJ may select the “Show” button to reset the audience display form. The DJ may select the “Show All” button to reveal all choices on the audience display form. The DJ may select the “Wrong” button triggering the display of the graphic “X” on the audience display form.

At decision block 2416, a test is performed to see if the DJ closed the form. If so, the system closes any open audience display forms at block 2418, closes the DJ form and returns control back to the main DJ form.

At decision block 2420, a test is performed to see if the “Show” button was clicked. If so, the audience display form is reset based on current variable values at block 2422. Control then passes back to block 2414.

At decision block 2424, a test is performed to see if the “Show All” button was clicked. If so, a flag is set by way of a public variable in the audience display form at block 2426. Control passes back to block 2414.

Block 2428 is passed control if the “Wrong” button is clicked. The incorrect counter is set to 4 causing the graphic “X” to be displayed for 4, 250 millisecond cycles of Timer 2. Control then passes back to block 2414.

FIG. 25 is a flow diagram illustrating a flow for a process called when a list guess button is clicked on the main DJ form.

At block 2504 the data filter is set to include only list items for the current list as determined by the global variable for current list identifier. At block 2506, the DJ form is opened on the DJ display and the corresponding audience display form is opened at block 2508. At block 2510 the data grid on the DJ form is filled with data from the list item data source. At block 2512 two timers are started. Timer 1 is used to poll the data grid on the DJ form looking for items that have been checked by the DJ. Timer 2 is used to control the display of information on the audience display form. As items are checked by the DJ and identified by Timer 1, variables within the audience display form are set. Timer 2 monitors these values and automatically reveals corresponding items on the audience form as items are checked on the DJ form. This dual timer process prevents the DJ from having to switch focus to the audience form enhancing the continuity of the game.

The Timer 1 process is as follows. At block 2530, a 700 millisecond wait is performed. At block 2532, the system polls the items within the data grid displayed on the DJ form. The list items for rows that are checked are placed into public memory variables within the audience display form at block 2534. Control then returns to block 2530.

Timer 2 performs 2 functions. It monitors variables within the audience form and reveals choices as they are selected. It also controls the display of a graphic used to designate an incorrect answer by the audience. Because it is desirable to poll for new updates to the form selections frequently, every 250 milliseconds, and because it is desirable to display the incorrect answer graphic for longer than 250 milliseconds, a counter is used. The Timer 2 process is as follows. At block 2536, a 250 millisecond wait is performed. At decision block 2538 the cycle counter controlling the display of the incorrect choice graphic is examined. It the counter value is greater than zero control passes to block 2540 where the counter is decremented. If the counter value is not greater than zero, the incorrect choice graphic is hidden at block 2542. Control then passes to block 2544. At block 2544, the public variables are examined and choices are revealed to the audience for any variable values set to true by the DJ form. Control then passes back to block 2536.

At block 2514, the DJ form receives input from the DJ. The DJ may opt to close the form using the standard Windows X button. The DJ may select the “Show” button to reset the audience display form. The DJ may select the “Show All” button to reveal all choices on the audience display form. The DJ may select the “Wrong” button triggering the display of the graphic “X” on the audience display form.

At decision block 2516, a test is performed to see if the DJ closed the form. If so, the system closes any open audience display forms at block 2518, closes the DJ form and returns control back to the main DJ form.

At decision block 2520, a test is performed to see if the “Show” button was clicked. If so, the audience display form is reset based on current variable values at block 2522. Control then passes back to block 2514.

At decision block 2524, a test is performed to see if the “Show All” button was clicked. If so, a flag is set by way of a public variable in the audience display form at block 2526. Control passes back to block 2514.

Block 2528 is passed control if the “Wrong” button is clicked. The incorrect counter is set to 4 causing the graphic “X” to be displayed for 4, 250 millisecond cycles of Timer 2. Control then passes back to block 2514.

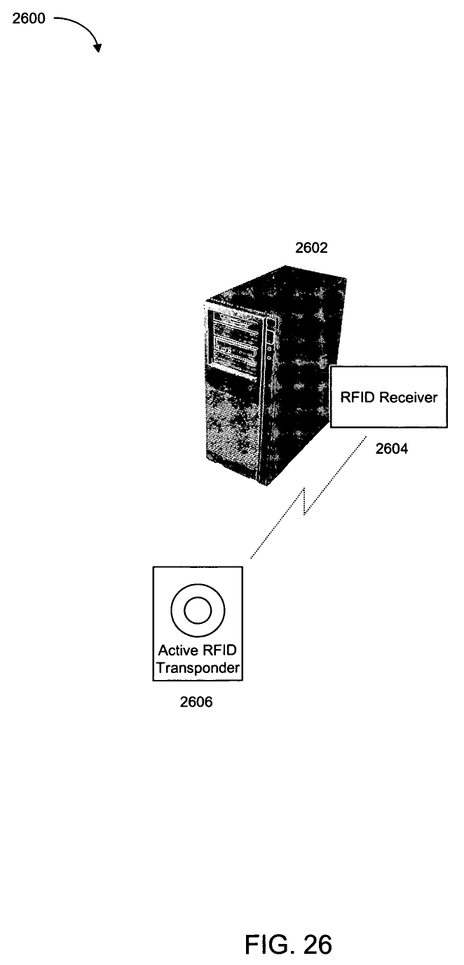

FIG. 26 is a pictorial diagram illustrating an optional set of game components that can be used to provide audience members with a sophisticated way to indicate when they want to respond to a question. The functionality is similar to “buzzers” used in TV game shows to “buzz in” once the contestant knows the correct answer. The embodiment illustrated is a wireless process, however. The DJ computer 2602 is equipped with an remote frequency identification (RFID) receiver 2604. Audience members are provided with button-activated, active RFID transponders 2606. Audience members register their names/nicknames when they receive their transponders. The trivia program 120 includes logic to sequence the RFID identifiers in the order that RFID transponder buttons were pressed. An audience display pop-up can then show the nicknames, in sequence, by which participants are given a chance to respond to the current question.

Some embodiments are directed to a trivia entertainment system comprising: a library of media elements such including digital music and/or videos; a media player that can be a portable device or computer-based application; a database of trivia questions and facts classified according to category; a plurality of display devices to support hosted operation where the host is able to (or is only optionally ale to, or alternatively, can not) control the game from a host console using one or more display devices, game participants are able to see content displayed on one or more display devices and the information displayed to the host is independently controlled from information displayed to the audience; a media-driven operation where the currently playing media element is the basis for determining what facts and trivia are available for the host to select from the host console and when the media element changes the pool of available facts and trivia changes as well; free-association selection process where the currently available pool of facts and trivia are directly related to the currently playing media element, indirectly related to the currently playing media element (for example artist and album trivia indirectly relates to the song being played), are freely associated by common attributes such a date, year, keyword, name or are generic in nature and available for all media elements; and/or free-form operation where the host controls what facts and trivia are presented for each media element, in what order the facts and trivia are presented and what hints are provided.

Some embodiments are directed to a system and method for each game licensee to customize the database of facts and trivia by supplementing the standard content comprising: system functionality to categorize facts and trivia as being part of the global system, private to the individual licensee or private and specific to a trivia event/gig to be hosted; system functionality enabling licensees to add their own private and gig-specific content to the database; and/or system functionality to assign a higher sequencing priority to content added by the licensee.

Some embodiments are directed to a system and method for distributing trivia, facts, information and/or song lyrics as part of an online digital media store comprising: the ability to distribute trivia, facts, information that relates to a particular song, video, book or other unit of online purchase on the basis of common attributes; the ability to distribute song lyrics stanzas and timings relative to recorded song. The media element may be, for example, one or more of: a digital song, a digital video, a digital image, and a digital publication. The class for trivia questions/hints may be one or more of: a musical album, a category of song, a musical artist or other artist, a historical event, a television show, a movie, miscellaneous, miscellaneous trivia, and/or jokes. Another class may be lists, where interesting lists being year-specific or not year-specific are recorded and trivia can be related to individual list items.

Examples of an attribute for matching between a recording attribute and an attribute of a hint and/or a trivia item are: common date, common year, common name, common title, common geographic location, common author/performer, common genre, and/or common category. Examples of a trivia item are: associated images, answers to trivia questions that are fill-in-the-blank, multiple choice answers to trivia questions, a prompt to guess the artist, a prompt to guess the song, a prompt to guess the album, a prompt to guess a TV show, a prompt to guess a movie title, trying to identify elements of a list, trying to identify the TV shows from a particular year, trying to identify the movies from a particular year, a prompt to guess the release year of the currently playing media element. Examples of hints are: a TV show from the release year, a movie from the release year, an alphabetic guessing game as a hint mechanism as in the game known as hangman. Examples of trivia are multiple choice answers are randomly sequenced each time they are displayed, answers to multiple choice questions are pre-established and stored within the database, multiple choice answers selected from a group of potential answers that may exceed the actual number displayed to the user.

In general, embodiments may include media player controls embedded into the host console display, trivia questions and guessing hints that are flagged when used and are thereafter hidden from display for the remainder of the current trivia session or until the host elects to reincorporate them. Database updates with continually expanding content may be made available to system licensees. Text can be synchronized to song playback for entertainment value. Individual lines of text or stanzas may be synchronized to the music by displaying them one at a time as the song is played back and by pressing a button when the appropriate timing occurs. The synchronized text can be one or more of: song lyrics, facts, trivia questions and answers, replacement song lyrics, associated with a specific rendition or recording of a song to account for unique timings, play length, lyrics and any other attributes that tend to differ for different recording of the same song by the same artist. In some embodiments, keeping score, by team or individual, for correct answers is a run-time option. In some embodiments, a system can operate in unattended mode and randomly select trivia items from the various trivia categories. In some embodiments, a system can operate in single user mode where there is no host.

In some embodiments, participants are provided with button-activated RFID transponders and the participant sequence for responding to a question is automatically established on a FIFO basis using an RFID receiver and the trivia application program.

In some embodiments, matching the currently playing media element to an associated item on the database can be accomplished by keeping a common, unique matching identifier as an attribute within the media player playlist items. Matching the artist for the currently playing song to an associated artist on the database can be accomplished by applying a compression algorithm to the artist name from the media player metadata and matching it against the compressed version of the artist name stored on the database. The compression algorithm converts all characters to same case, eliminates spaces and special characters and eliminates parenthetical text for more forgiving yet highly accurate matching. In some cases, matching the currently playing song element to an associated song on the database can be accomplished by applying a compression algorithm to the artist name and song title from the media player metadata and matching it against the compressed version of the artist name and song title stored on the database. The compression algorithm converts all characters to same case, eliminates spaces and special characters and eliminates parenthetical text for more forgiving yet highly accurate matching. Some embodiments include settings whereby users may acquire trivia and other content related to media elements that they already own.

Various embodiments have been described herein with a variety of components and subcomponents. In general, the components and subcomponents may be mixed-and-matched to make other embodiments, as guided by the requirement that the resultant device be functional.

What is claimed is:

1. A trivia entertainment system comprising:
a computing device,
a host display,
a viewer display,
a computer-readable medium,
a library of media elements comprising musical and/or video recordings that are each associated with a plurality of attributes, said library being stored on the computer-readable medium,
a media player for playing the recording according to selection by a host or a predetermined playlist,
a database comprising trivia records each associated with one or more attributes, said database being stored on the computer-readable medium,
with the computing device
providing a graphical user interface controllable by a host on the host display,
having access to the library and the database, being programmed to match attributes of the recordings with attributes of the trivia records to provide a plurality of trivia catalogs to the graphical user interface, and
being programmed to respond to the graphical user interface to display a portion of the trivia on the viewer display,
wherein the graphical user interface
provides integration with the media player to retrieve and display the attributes of the recording on the host display,
exhibits the plurality of trivia catalogs, and
provides for host-selection of a trivia item from the plurality of trivia catalogs to display on the viewer display.

2. The system of claim 1 wherein the recording attributes comprise a member of the group consisting of a year associated with the recording, a name of a performer on the recording, a record label that released the recording, a title of the recording, an author of the recording, a composer of the recording, and combinations thereof.

3. The system of claim 1 further comprising a plurality of the viewer displays.

4. The system of claim 1 wherein the computing device is a computer that comprises the computer-readable medium for the library, or the database, or both the library and the database.

5. The system of claim 1 wherein the audio media player is controllable through the graphical user interface to play the recording, with the recording being a musical recording.

6. The system of claim 1 wherein the recording is taken from the predetermined play list and automatically played.

7. The system of claim 1 further providing for host control of the media player through the graphical user interface.

8. The system of claim 1 further comprising: computer-executable instructions to receive and integrate into the database user-created data that comprises one or more of: (a) a public/private indicator attribute; (b) a gig-specific attribute; or (c) a sequence value attribute providing capability for setting higher sequencing priority to the user-created data relative to other data.

9. The system of claim 1 further comprising an RFID transponder controllable by a viewer to respond to trivia with an RFID identifier, and executable instructions to receive, process and sequence RFID identifiers provided by viewer activation of the RFID transponder.

10. A method of playing a hosted game with viewers that interact with a viewer display comprising:
providing an entertainment system that comprises a computing device, a host display, a viewer display, a computer-readable medium, a library of media elements comprising musical and/or video recordings that are each associated with attributes, said library being stored on the computer-readable medium, a media player, a database comprising trivia records each associated with one or more attributes, said database being stored on the computer-readable medium, and a host graphical user interface controllable on the host display,
selecting the recording for playing by a host or a predetermined playlist, with the system retrieving and displaying a plurality of attributes of the host-selected recording in the graphical user interface,
matching, with the computing device, attributes of the recording with attributes of the trivia records to provide a plurality of trivia catalogs to display in the graphical user interface, and
selecting at least one of the trivia items from at least one of the trivia catalogs via the graphical user interface to direct the controller to display the at least one selected trivia item on the viewer display.

11. The method of claim 10 further comprising a plurality of viewer displays that display the selected questions and/or facts.

12. The method of claim 11 wherein the controller is a computer that comprises the computer-readable medium for the library, or the database, or both the library and the database.

13. The method of claim 10 wherein the media player is controlled through the graphical user interface to play the recording.

14. The method of claim 10 comprising the predetermined playlist.

15. The method of claim 10 wherein the recording attributes comprise a member of the group consisting of a year associated with the recording, a name of a performer on the recording, a record label that released the recording, a title of the recording, an author of the recording, a composer of the recording, and combinations thereof.

16. The method of claim 15 wherein the trivia attributes include a year, and the computing device matches the year of the recording with the year of one of the trivia records, and the GUI provides the catalogs in separate classes.

17. The method of claim 10 comprising: providing computer-executable instructions to receive and integrate into the database user-created data that comprises one or more of: (a) a public/private indicator attribute; (b) a gig-specific attribute; or (c) a sequence value attribute providing capability for setting higher sequencing priority to the user-created data relative to other data.

18. The method of claim 10 further comprising providing an RFID transponder controllable by a viewer to respond to trivia with an RFID identifier, and executable instructions to receive, process and sequence RFID identifiers provided by viewer activation of the RFID transponder.
